(19) United States
(12) Patent Application Publication
(10) Pub. No.: US 2021/0209543 A1
(43) Pub. Date: Jul. 8, 2021

(54) DIRECTING SECONDARY DELIVERY VEHICLES USING PRIMARY DELIVERY VEHICLES

(71) Applicant: Amazon Technologies, Inc., Seattle, WA (US)

(72) Inventors: Sean M. Scott, Sammamish, WA (US); Timothy James Ong, Redmond, WA (US)

(21) Appl. No.: 16/735,287

(22) Filed: Jan. 6, 2020

(51) Int. Cl. G06Q 10/08; B60R 11/04; B60P 3/00; B60P 3/06; G05D 1/02

(52) U.S. Cl. CPC G06Q 10/083; B60R 11/04; B60P 3/007; G05D 2201/0213; G05D 1/0246; G05D 1/0285; B60P 3/06

(57) ABSTRACT

Primary vehicles having cameras or other sensors generate and transmit instructions for causing secondary vehicles, such as personal delivery devices, to travel on selected courses and speeds. The primary vehicles capture and process images or other data to determine positions or orientations of the secondary vehicle, to detect any obstacles, and to select courses or speeds for the secondary vehicle based on the locations of the obstacles or one or more objectives of a task or function. Alternatively, the secondary vehicles may also capture images or other data, and transmit the images or data to the primary vehicle for processing. The secondary vehicles may include one or more fiducials having visual markings thereon. The visual identifiers are fixed in their orientations with respect to the secondary vehicles, such that positions or orientations of the secondary vehicles may be determined upon detecting the markings within imaging data.

### BACKGROUND

Items that are ordered from electronic marketplaces, bricks-and-mortar merchants, or from any other sources may be delivered to one or more predetermined destinations in any number of vehicles. For example, items may be delivered from an origin (e.g., a source of the items) to destinations in one or more cars, trucks, tractors, vans or other automobiles, which may be operated manually, e.g., by one or more drivers, couriers, associates or other personnel, or autonomously, e.g., upon executing one or more computer-based instructions.

Personal delivery devices, such as autonomous ground vehicles or robots, are being increasingly utilized in the performance of a number of commercial applications, personal tasks, and other functions. For example, such devices have been utilized to complete deliveries of items to locations or personnel indoors or outdoors, or, alternatively, to survey ground conditions, to monitor traffic, or to identify situations requiring alternative or additional assistance from humans or other machines.

Personal delivery devices are commonly outfitted with suites of sensors of varying types. For example, a personal delivery device may include any number of digital cameras mounted to a body or frame, and such digital cameras may be aligned with fields of view that are pointed forward, aft, alongside or above the personal delivery device, and configured to capture visual imaging data, depth imaging data, or any other imaging data regarding surroundings or environments in which the personal delivery device is operating. Additionally, a personal delivery device may also include any number of navigational sensors, e.g., position sensors, accelerometers, gyroscopes, compasses or other magnetometers, as well as any inclinometers, ranging sensors (e.g., radar, sonar or LIDAR ranging sensors) or acoustic sensors. Furthermore, in order for a personal delivery device to operate equipment such as digital cameras, navigation sensors, or other sensors, or to engage in communications with other systems, the personal delivery device must typically include one or more computer systems or other processor units, as well as hard drives, transceivers, antennas or other computer equipment.

A sensor suite may provide a personal delivery device with a number of benefits or advantages. However, such benefits or advantages may typically come at a price, as cameras, navigation equipment, processors, hard drives or transceivers may greatly increase the cost of the personal delivery device. Moreover, where a personal delivery device is small in size, a sensor suite may limit its effectiveness, as such sensors may take up valuable space within a body of a personal delivery device that might otherwise be occupied by items to be delivered to destinations specified by customers.

### BRIEF DESCRIPTION OF THE DRAWINGS

FIGS. 1A through 1N are views of aspects of one system for directing secondary vehicles using primary vehicles in accordance with embodiments of the present disclosure.

FIG. 2 is a block diagram of components of one system for directing secondary vehicles using primary vehicles in accordance with embodiments of the present disclosure.

FIG. 3 is a flow chart of one process for directing secondary vehicles using primary vehicles in accordance with embodiments of the present disclosure.

FIGS. 4A through 4H are views of aspects of one system for directing secondary vehicles using primary vehicles in accordance with embodiments of the present disclosure.

FIGS. 5A and 5B are views of aspects of one system for directing secondary vehicles using primary vehicles in accordance with embodiments of the present disclosure.

FIGS. 6A and 6B are a flow chart of one process for directing secondary vehicles using primary vehicles in accordance with embodiments of the present disclosure.

FIGS. 7A through 7D are views of aspects of one system for directing secondary vehicles using primary vehicles in accordance with embodiments of the present disclosure.

### DETAILED DESCRIPTION

As is set forth in greater detail below, the present disclosure is directed to directing secondary vehicles, such as personal delivery devices, using primary vehicles. More specifically, some embodiments of the systems and methods disclosed herein are directed to using one or more vehicles (e.g., “primary vehicles”) that are outfitted or configured with one or more sets of sensors, computer devices, and communications equipment to control the operations of one or more personal delivery devices or other vehicles (e.g., “secondary vehicles”) that need not be outfitted with sensors, computer devices, and communications equipment in the same number or of the same levels of quality, complexity, sophistication, technology or advancement.

For example, in some embodiments, a primary vehicle that is outfitted or configured with digital cameras or other sensors, as well as control systems, navigation systems, transceivers and processors, may generate instructions for a secondary vehicle, such as a personal delivery device, that is not similarly equipped to perform a task or function involving travel between two locations or positions based on data captured by the sensors of the primary vehicle. Such tasks or functions may include but are not limited to deliveries of items. The instructions may be selected on any basis, including locations or positions of the secondary vehicle or any obstructions, as well as one or more requirements of a given task or function. The secondary vehicle may be equipped with one or more extensions or appurtenances having distinct appearances that increase a likelihood that the secondary vehicle will be detected within imaging data captured by the primary vehicle.

In some embodiments, a secondary vehicle may be outfitted or configured with a digital camera, a position sensor, or another sensor. The secondary vehicle may capture data (e.g., one or more images, position data, or others) and transmit the data to a primary vehicle, which may process the data and select a course or a speed for the secondary vehicle based on the data.

In some embodiments, a primary vehicle and one or more secondary vehicles may travel together to a location associated with a task or function (e.g., a delivery of one or more items). For example, the primary vehicle may carry the one or more secondary vehicles (e.g., personal delivery devices) to the location, or be coupled to the one or more secondary vehicles, e.g., in a chain or other arrangement. Upon arriving at the location, the primary vehicle may discharge or decouple from one or more of the secondary vehicles, and generate and transmit instructions to the secondary vehicles for performing one or more tasks or functions. Alternatively, in some embodiments, a primary vehicle and a secondary vehicle may travel together to a location, in an uncoupled state or condition, but within a communication range of one another, and with the secondary vehicle traveling on courses or speeds selected in response to instructions received from the primary vehicle. Upon completing the tasks or functions, the primary vehicle may program a secondary vehicle to return to a location of the primary vehicle, or to travel to another location or position, e.g., to perform another task or function.

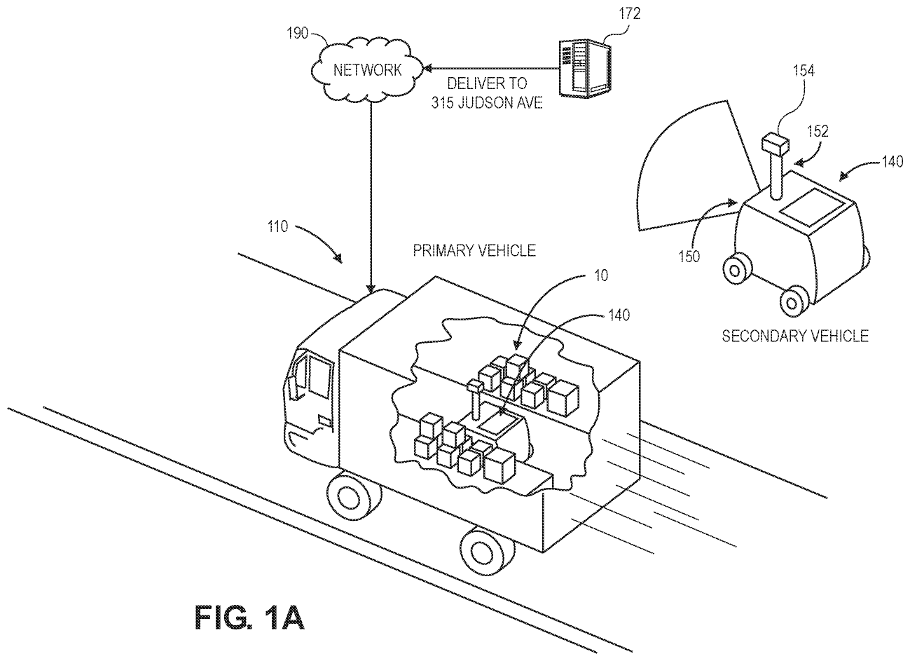

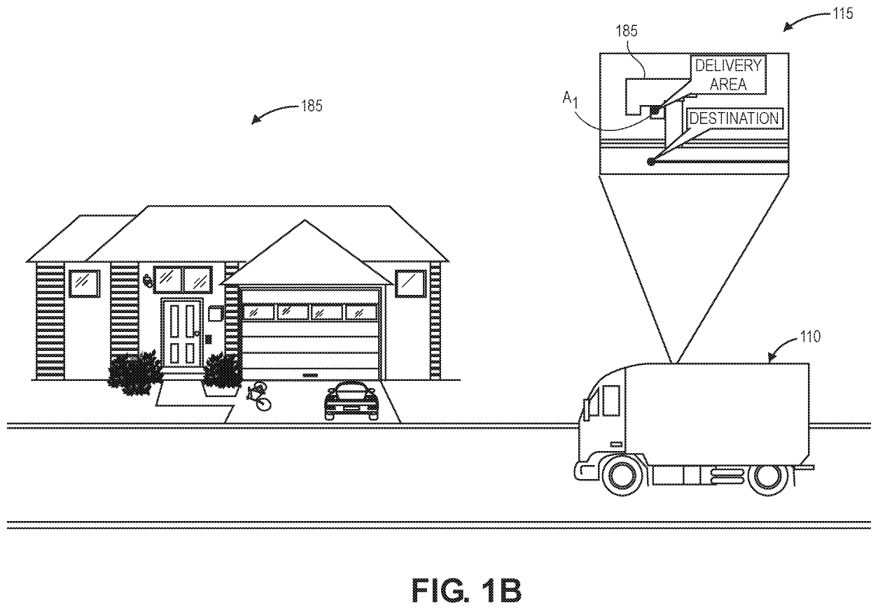

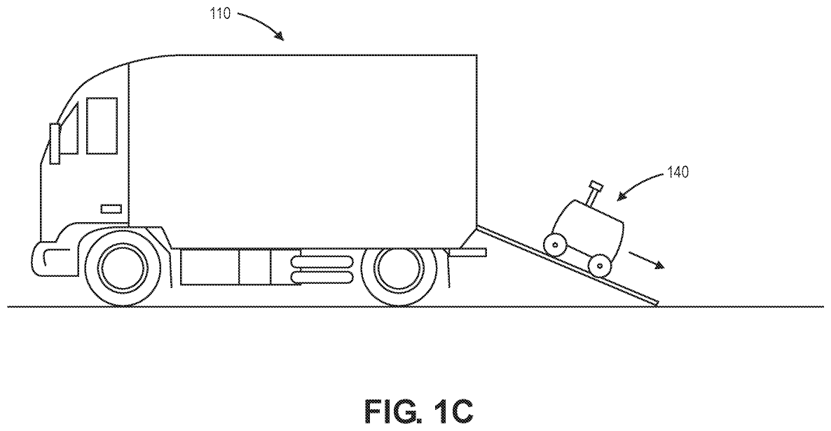

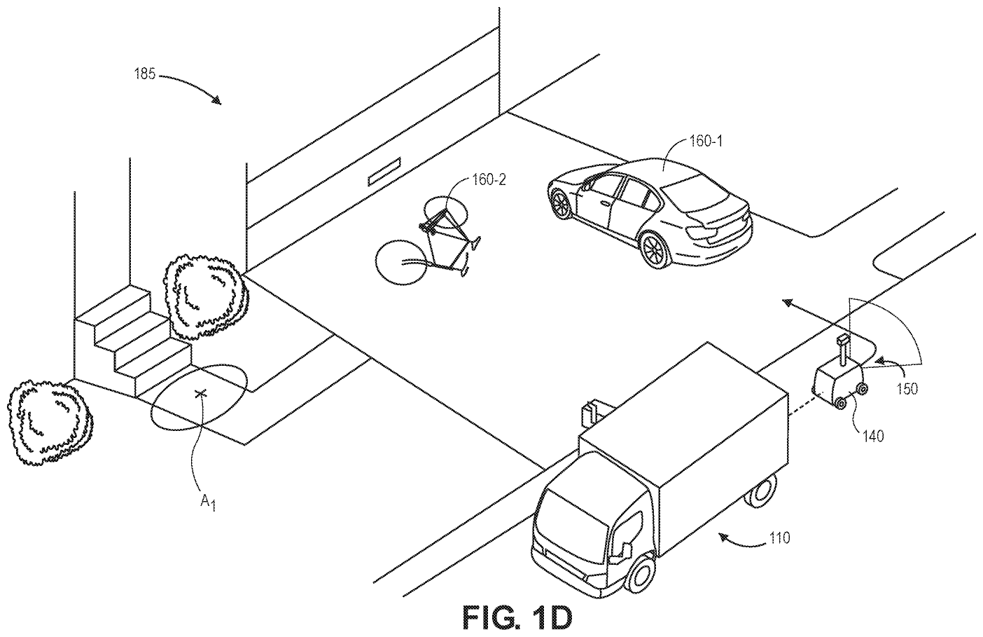

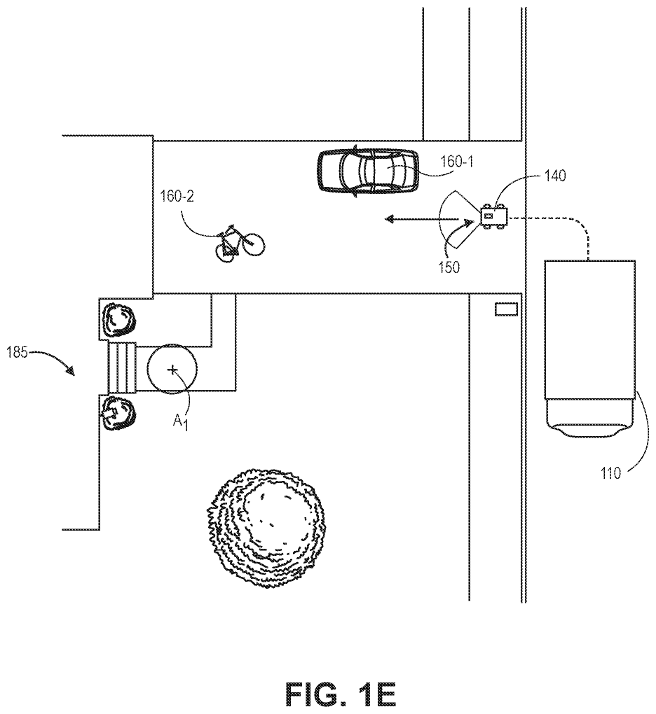

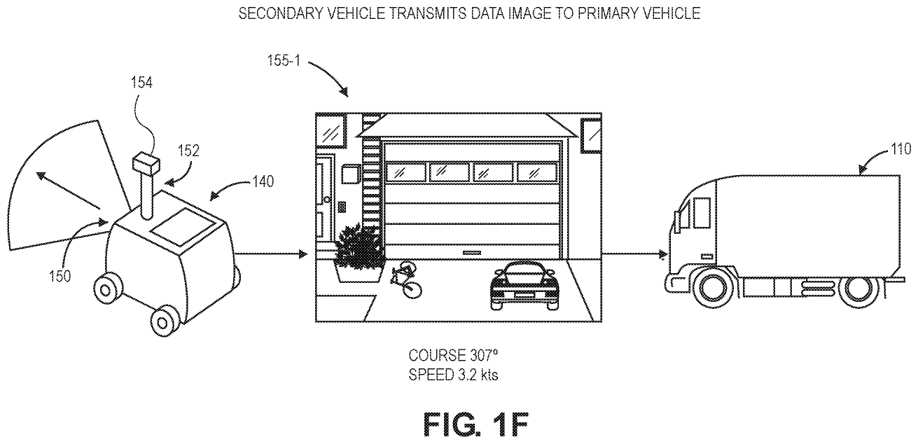

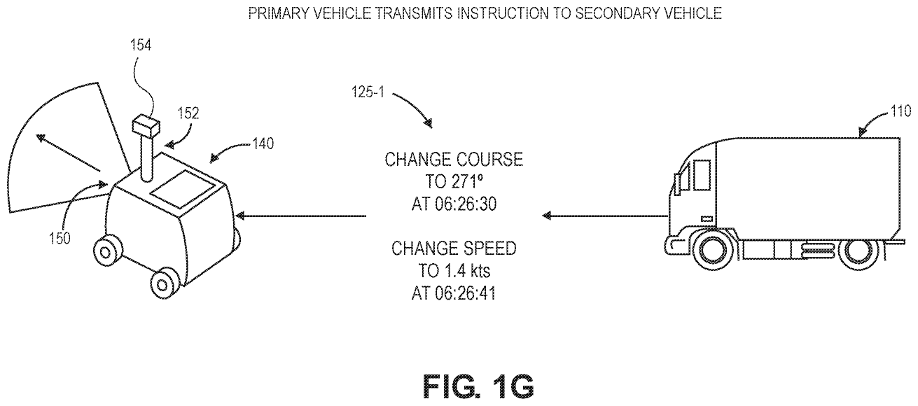

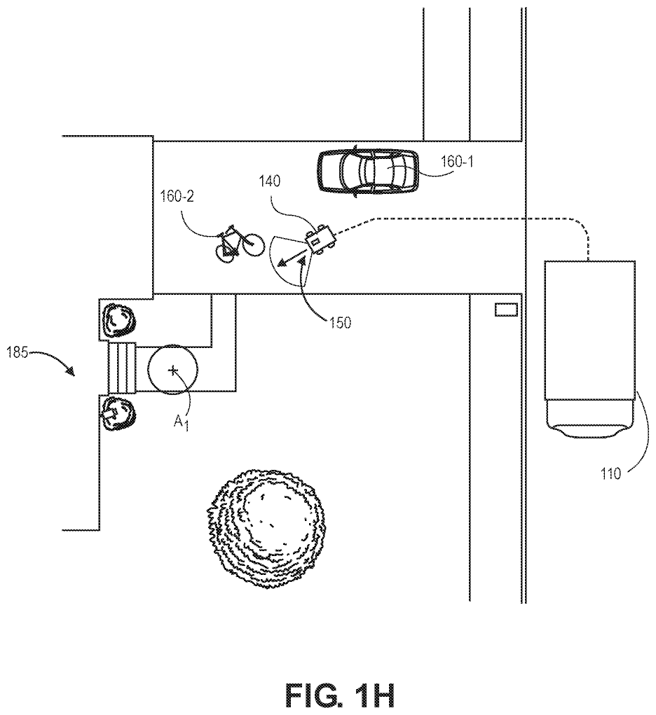

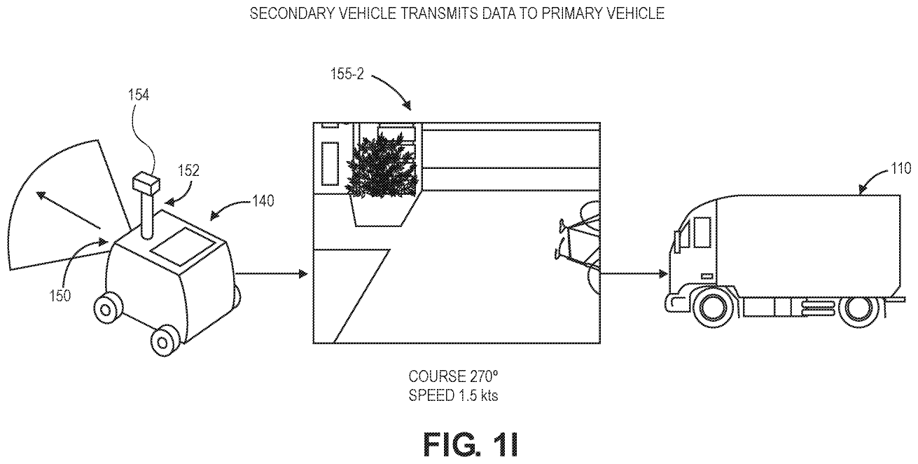

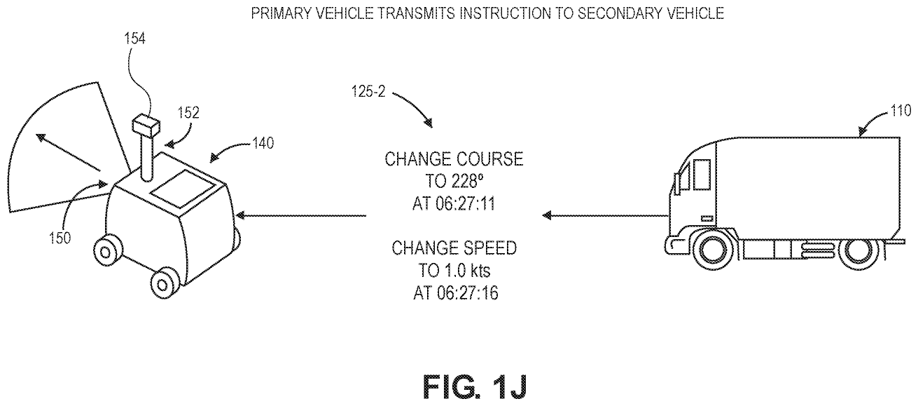

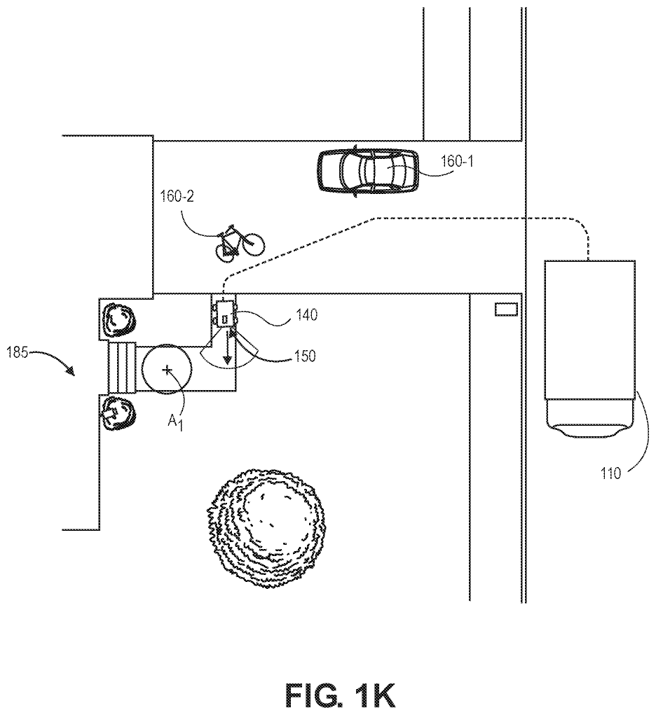

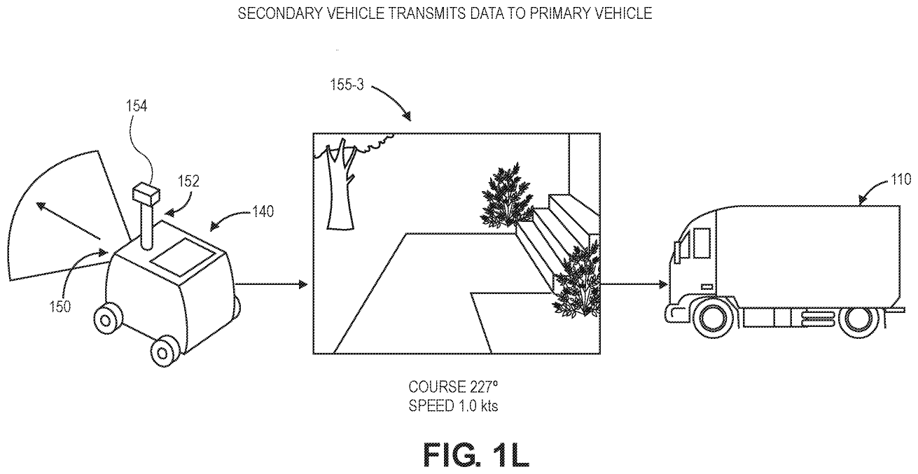

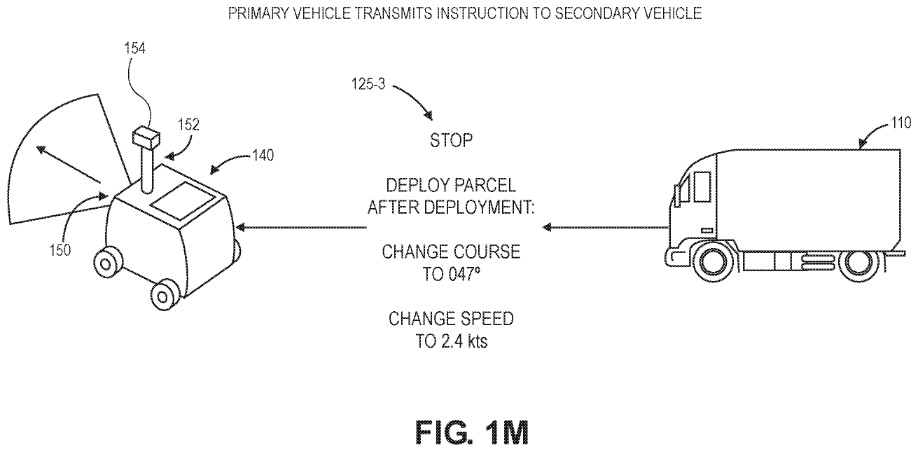

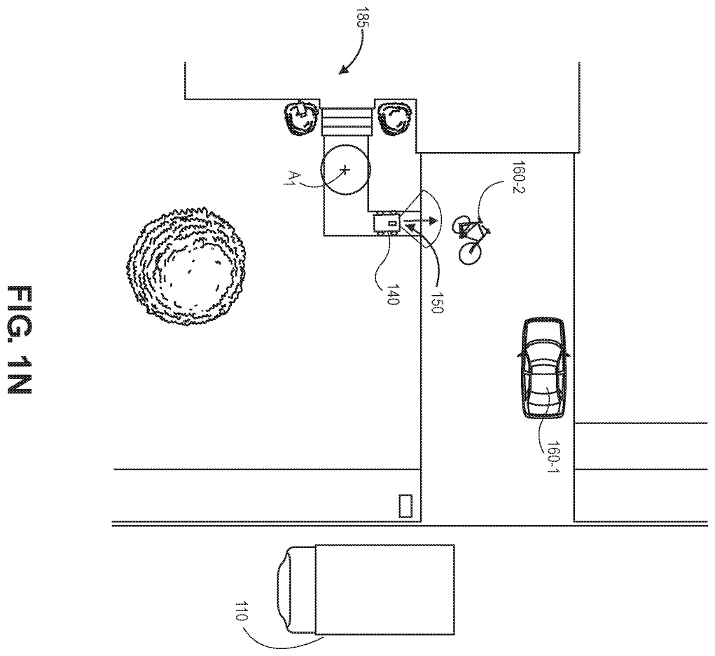

Referring to FIGS. 1A through 1N, views of aspects of one system for directing secondary vehicles using primary vehicles in accordance with embodiments of the present disclosure are shown. As is shown in FIG. 1A, a primary vehicle 110 carries a secondary vehicle (e.g., a personal delivery device) 140 and a plurality of items 10 to a designated destination, to complete a delivery of one or more of the items 10. The primary vehicle 110 is in communication with one or more external servers 172 or other computer devices, which may be associated with a fulfillment center, a materials handling facility, an electronic marketplace, or any other individual or entity, over a network 190. The secondary vehicle 140 is within a cargo bay, a storage compartment or another space of the primary vehicle 110, along with the items 10.

The primary vehicle 110 may be an automobile such as a car, a truck, a van, a tractor, or any other type or form of vehicle that is operated manually (e.g., by one or more drivers, couriers, associates or other personnel, not shown) or autonomously. Additionally, the secondary vehicle 140 may be an autonomous robot or another autonomous vehicle having one or more wheels, legs or other systems for traveling on ground surfaces that is configured to receive instructions or other information or data from the primary vehicle 110 and to execute such instructions in the performance of the one or more tasks or functions, such as a delivery of the ordered item. As is shown in FIG. 1A, the secondary vehicle 140 comprises at least one imaging device 150 provided on a forward or front surface thereof and having a field of view that extends forward of the secondary vehicle 140. The secondary vehicle 140 further includes a fiducial 152 that extends above a body of the secondary vehicle 140 (e.g., normal to an upper surface of the body), to fixed or variable heights, and includes an extension 154 on a distal end. The extension 154 of the fiducial 152 may be an object that has a fixed orientation with respect to an orientation of the secondary vehicle 140, and includes one or more discrete visible markings on respective faces. Therefore, upon detecting the fiducial 152 and/or the extension 154 within an image, a position and/or an orientation of the secondary vehicle 140 may be determined based on the appearance of the respective visible markings within such images.

As is shown in FIG. 1B, the primary vehicle 110 may be programmed with a map 115 or other representation or set of instructions for traveling to a destination 185 for the ordered items. The map 115 may identify not only a location or position (e.g., by coordinates, position data or other information or data) at which the primary vehicle 110 may park or idle when completing the delivery to the destination 185 but also a delivery area Ai at the destination 185 where the ordered items should be delivered. The map 115 may further specify a route to be traveled by the primary vehicle 110. Alternatively, the primary vehicle 110 may calculate one or more paths or a route to the destination 185 based on the map 115, e.g., according to one or more optimal path or route (or shortest path or route) algorithms, or in any other manner. As is shown in FIG. 1C, upon arriving at the destination 185, the secondary vehicle 140 may exit or otherwise be removed from the cargo bay or other storage compartment of the primary vehicle 110, either under power of one or more onboard motors, or with assistance of one or more external personnel or machines.

In accordance with embodiments of the present disclosure, the secondary vehicle 140 may operate under the direction and control of the primary vehicle 110 when performing a task or function, e.g., a delivery of the ordered items, to the delivery area Ai at the destination 185. As is shown in FIG. 1D, the secondary vehicle 140 may depart the primary vehicle 110 and travel toward the delivery area Ai at the destination 185 in accordance with one or more sets of instructions received from the primary vehicle 110. For example, the primary vehicle 110 and the secondary vehicle 140 may be configured for communication via any wired or wireless systems or protocols, including but not limited to Bluetooth®, Wireless Fidelity (or “Wi-Fi”), or any other type of systems, protocols or network, e.g., a proprietary system, protocol or network, either directly or over a network, e.g., the network 190.

Additionally, as is shown in FIGS. 1D and 1E, the imaging device 150 of the secondary vehicle 140 may be configured to capture imaging data (e.g., visual images or depth images), as well as audio signals or any associated information, data or metadata, as the secondary vehicle 140 travels in accordance with instructions received from the primary vehicle 110 toward the destination 185. The secondary vehicle 140 may be configured to transmit any such imaging data or other information or data to the primary vehicle 110, which may process the imaging data or other information or data, e.g., to detect and locate any number of obstructions 160-1, 160-2, and select one or more courses or speeds, or other actions, for the secondary vehicle 140 based on such imaging data or other information or data. Alternatively, the secondary vehicle 140 need not include any imaging devices or other sensors, and may instead operate exclusively under control of the primary vehicle 110, which may include any number or type of sensors (not shown), such as digital cameras, which may capture any type or form of data regarding the surroundings or the environments in which the primary vehicle 110 or the secondary vehicle 140 are operating in accordance with embodiments of the present disclosure.

For example, as is shown in FIG. 1F, the secondary vehicle 140 transmits data 155-1 including an image captured by the secondary vehicle 140, as well as a course and a speed at which the secondary vehicle 140 is traveling (viz., a course of 307° and a speed of 3.2 knots) to the primary vehicle 110, which processes the data 155-1 to identify any obstructions or other features depicted therein, and generates one or more instructions for operating the secondary vehicle 140 based on the data 155-1, as well as one or more requirements of a given task or function. In some embodiments, such as where the secondary vehicle 140 is outfitted with one or more position sensors, navigation sensors, or other equipment or components, the data 155-1 may include data in addition to the image, the course or the speed, such as a position of the secondary vehicle 140 at a time that the data 155-1 was captured, as well as any information or data regarding angles or orientations of the secondary vehicle 140. In some embodiments, however, the data 155-1 may include only the image or only the course and speed.

In still other embodiments, however, such as where the primary vehicle 110 is outfitted with one or more cameras or other imaging devices, the secondary vehicle 140 need not include any additional sensors, and the primary vehicle 110 may capture data (e.g., imaging data or other information or data) as the secondary vehicle 140 travels. In such embodiments, the primary vehicle 110 may process data captured thereby, and generate one or more instructions for subsequent operations of the secondary vehicle 140 based on the captured data.

As is shown in FIG. 1G, upon processing the data 155-1 received from the secondary vehicle 140, the primary vehicle 110 may process the data 155-1 to determine a position and/or an orientation of the secondary vehicle 140, and to generate one or more instructions for executing course changes or speed changes or other actions by the secondary vehicle 140 based on the position or the orientation of the secondary vehicle 140, or positions or orientations of any other objects. For example, as is shown in FIG. 1G, the primary vehicle 110 transmits a set of instructions 125-1 for causing the secondary vehicle 140 to execute a change in course and a change in speed at future times designated in the set of instructions 125-1. In some embodiments, however, the instructions 125-1 may predicate a change in course, a change in speed, or any other action, based on a location or position of the secondary vehicle 140 or any other factors or events. As is shown in FIG. 1H, upon receiving the set of instructions 125-1 from the primary vehicle 110, the secondary vehicle 140 executes the change in course and the change in speed as scheduled, thereby avoiding one of the obstacles 160-2 depicted within the data 155-1, and causing the secondary vehicle 140 to further approach the delivery area Ai at the destination 185.

In accordance with embodiments of the present disclosure, the secondary vehicle 140 may continuously capture data during operations, and transmit the data to the primary vehicle 110, which may process the captured data and generate sets of instructions for the secondary vehicle 140 to execute changes in course or speed, or to perform any other actions, as necessary. For example, as is shown in FIG. 1I, the secondary vehicle 140 transmits data 155-2 including an image captured by the secondary vehicle 140, as well as a course and a speed at which the secondary vehicle 140 is traveling (viz., a course of 270° and a speed of 1.5 knots) to the primary vehicle 110. As is shown in FIG. 1J, the primary vehicle 110 generates a set of instructions 125-2 based on the data 155-2, with such instructions also calling for the secondary vehicle 140 to execute a change in course and a change in speed at future times designated in the set of instructions 125-2. As is shown in FIG. 1K, upon receiving the set of instructions 125-2 from the primary vehicle 110, the secondary vehicle 140 executes the change in course and the change in speed as scheduled, thereby causing the secondary vehicle 140 to travel along a path leading to the delivery area Ai at the destination 185.

Likewise, as is shown in FIG. 1L, the secondary vehicle 140 transmits data 155-3 including an image captured by the secondary vehicle 140, as well as a course and a speed at which the secondary vehicle 140 is traveling (viz., a course of 227° and a speed of 1.0 knots) to the primary vehicle 110. As is shown in FIG. 1M, upon determining that the secondary vehicle 140 is approaching the delivery area Ai at the destination 185 based on the data 155-3, the primary vehicle 110 generates a set of instructions 125-3 to cause the secondary vehicle 140 to stop, to deploy a parcel including the ordered items at the delivery area Ai, e.g., in an attended or an unattended delivery, before executing a change in a course and a speed after deploying the parcel in order to return to the primary vehicle 110.

As is shown in FIG. 1N, upon receiving the set of instructions 125-3 from the primary vehicle 110, the secondary vehicle 140 reverses course and executes a change in speed as scheduled, thereby causing the secondary vehicle 140 to travel along a path and to eventually return to the primary vehicle 110. For example, while en route to the primary vehicle 110, the secondary vehicle 140 may continue to capture images or other data and transmit the data to the primary vehicle 110, which may assess the data received from the secondary vehicle 140 and instruct the secondary vehicle 140 to execute one or more changes in course or speed, or to take any other actions, based on the data.

Accordingly, the systems and methods of the present disclosure are directed to controlling the operations of one ground vehicle (e.g., one delivery vehicle) by instructions of another vehicle, which may be another ground vehicle or an aerial vehicle (e.g., another delivery vehicle), for purposes that may include but are not limited to the delivery of one or more items. In some embodiments, a primary vehicle (or a first vehicle) and a secondary vehicle (or a second vehicle) may travel to a location associated with a destination. The primary vehicle and the secondary vehicle may be coupled to one another, either physically (e.g., the secondary vehicle may be carried to the location by the primary vehicle), or functionally (e.g., the secondary vehicle may travel alongside or near the primary vehicle, within a communications range of the primary vehicle, and may operate subject to one or more instructions received from the primary vehicle). Alternatively, the primary vehicle and the secondary vehicle may travel independently to the location. Upon arriving at the location, the primary vehicle may transmit one or more instructions for causing the secondary vehicle to travel on a selected course or at a selected speed, or to take any other relevant action. The instructions may include electronic messages or signals of any type or form, and may instruct (or otherwise program) the secondary vehicle to travel in any designated manner, such as at a selected velocity (e.g., a selected course and a selected speed), at or until a selected time, for a selected duration (e.g., between selected times), to or through selected locations or positions, or in any other manner. Additionally, the instructions may further include electronic messages or signals that are intended to cause the secondary vehicle to take any other desired action, or any series of actions, such as to deploy an item at a predetermined location or position, to retrieve an item from a predetermined location or position, or any other relevant actions.

In some embodiments, the primary vehicle may be a ground vehicle, e.g., an automobile such as a car, a truck, a van, a tractor, or any other type or form of vehicle, which may be operated by one or more personnel aboard the ground vehicle or in other locations. In some embodiments, the primary vehicle may be an autonomous ground vehicle, e.g., an autonomous mobile robot, that is outfitted with one or more sensors, computer devices or systems, or other components that are programmed or otherwise configured to capture data regarding surroundings or environments in which the primary vehicle or a secondary vehicle is operating, and to select one or more actions to be taken by the primary vehicle or the secondary vehicle based on the captured data. In some embodiments, the primary vehicle may be an aerial vehicle, or an aquatic vehicle, that is either manned or unmanned and is also programmed or otherwise configured to capture data regarding surroundings or environments in which the primary vehicle or a secondary vehicle is operating, and to select one or more actions to be taken by the primary vehicle or the secondary vehicle based on the captured data.

In some embodiments, the functions or tasks performed or executed by a “primary vehicle,” as described herein, may be performed or executed by a remote computer system in communication with the secondary vehicle that may be fixed or mobile in nature. For example, where a secondary vehicle of the present disclosure is configured or equipped with one or more transceivers for communicating via one or more wireless networks, the secondary vehicle may receive one or more sets of instructions from a computer system over such networks. The computer system may be provided within a vicinity of the secondary vehicle, or in one or more alternate or virtual locations, e.g., in a “cloud”-based environment.

In some embodiments, the secondary vehicle may be a ground vehicle, e.g., an automobile such as a car, a truck, a van, a tractor, or any other type or form of vehicle, which may be programmed or otherwise configured to take any actions under one or more instructions (e.g., instructions carried by one or more wireless electronic messages or signals) received from the primary vehicle.

In some embodiments, the primary vehicle may be outfitted or equipped with a suite of sensors or other equipment for receiving instructions or other information or data from an external computer device or system, for transmitting instructions or other information or data to a secondary vehicle, for selecting velocities (e.g., courses or speeds), times or durations of operations, or locations or positions to be traveled to or therethrough by the primary vehicle or the secondary vehicle, for causing the primary vehicle to travel at one or more selected velocities, at one or more of such times, for one or more of such durations, to or therethrough one or more of such locations or positions, or for taking any other relevant actions.

In some embodiments, the secondary vehicle need not include any of the sensors of the primary vehicle, or may include a suite of sensors that omits or lacks one or more of the sensors of the primary vehicle. For example, in some embodiments, the secondary vehicle may include one or more transceivers for communicating with the primary vehicle, one or more motors for causing the secondary vehicle to travel on a course (e.g., on a heading or in a direction) selected by the primary vehicle, and one or more motors for causing the secondary vehicle to travel at a speed selected by the primary vehicle. Alternatively, in some embodiments, the secondary vehicle may include one or more sensors, such as position sensors or cameras, that are configured to capture data regarding positions of the secondary vehicle or images of surroundings or environments in which the secondary vehicle is operating. The data captured by the secondary vehicle may be transmitted to the primary vehicle, which may process or analyze the captured data and generate one or more instructions for the secondary vehicle based at least in part on the captured data before transmitting one or more of such instructions to the secondary vehicle. The sensors carried aboard the secondary vehicle may include, but are not limited to, one or more position sensors, speedometers (e.g., electronic or mechanical systems for determining changes in position over time, including but not limited to systems that operate based on eddy currents, visual odometry, or other techniques), inclinometers, thermometers, accelerometers, gyroscopes, compasses or other magnetometers, imaging devices (e.g., digital cameras), ranging sensors (e.g., radar, sonar or LIDAR ranging sensors) or acoustic sensors (e.g., microphones, vibration sensors), or others. The data captured by the secondary vehicle and returned to a primary vehicle may include, but is not limited to, images, position data or other sets of geographic coordinates (e.g., a latitude and a longitude, and, optionally, an elevation), angles, temperatures, accelerations, velocities, distances or ranges to objects, magnetic field strengths, images, sounds or others. Sensors aboard a secondary vehicle may return any type or form of data to a primary vehicle, and may receive one or more instructions from the primary vehicle, at any time, speed or rate, such as in real time or near-real time.

In some embodiments, a secondary vehicle may include one or more extensions or appurtenances that are intended to enhance the visibility of the secondary vehicle, e.g., to one or more sensors (such as digital cameras) provided on a primary vehicle. The extensions or appurtenances may be mounted to or carried by the secondary vehicle in a manner that places such extensions or appurtenances vertically above a body, a frame or another structure of the secondary vehicle, thus enabling the secondary vehicle to be more readily viewed or detected by a primary vehicle, even as the secondary vehicle travels around or among one or more objects (e.g., obstructions) having dimensions that are similar to or larger than those of the secondary vehicle. In some embodiments, the extensions or appurtenances may be mounted at substantially fixed heights above the body, the frame or the other structure of the secondary vehicle. In some embodiments, however, the extensions or appurtenances may be mounted at variable heights above the body, the frame or the other structure of the secondary vehicle, such as by telescoping or extendible systems that may be operated by one or more motors, hydraulic systems, pneumatic systems, or any other prime movers to place the extensions or appurtenances at such heights.

The extensions or appurtenances of the secondary vehicle may have appearances or other features that are fixed with respect to an orientation of the secondary vehicle. For example, such extensions or appurtenances may include a fiducial having one or more visible markings or surfaces thereon that remain fixed in their relative position with respect to the orientation of the secondary vehicle. The visible markings may include any type or form of bar codes (e.g., one-dimensional or two-dimensional bar codes, such as “QR” codes, or “AprilTags”), alphanumeric characters, symbols, or the like. The visible markings on a fiducial may be detected within imaging data captured using one or more digital cameras provided aboard or in association with a primary vehicle, and processed to determine positions or orientations of the visible marking (and, therefore, a position of the secondary vehicle) in three-dimensional space. The primary vehicle may then utilize the positions or orientations of the secondary vehicle to generate one or more instructions for controlling the operations of the secondary vehicle, and transmit such instructions to the secondary vehicle accordingly. Alternatively, in some embodiments, the fiducial may have an extension having a predetermined shape, e.g., a triangular prism, that may be fixed with respect to an orientation of a secondary vehicle. The shape of the fiducial may be detected and processed to determine positions and/or orientations of the fiducial and, therefore, the secondary vehicle, in three-dimensional space.

In some embodiments, the primary vehicles and the secondary vehicles of the present disclosure may be vehicles having any number of wheels mounted to axles that may be rotated by any number of motors, with dimensions, masses or other indicators of size that may be selected on any basis. For example, in some embodiments, the primary vehicles or the secondary vehicles may be sized and configured to travel on roads, sidewalks, crosswalks, bicycle paths, trails or the like, as well as yards, patios, driveways, sidewalks, walkways or other surfaces, at various times or during various levels of congestion, and at various speeds, e.g., in response to one or more computer-based instructions. Where a primary vehicle is an aerial vehicle, the primary vehicle may further include one or more propellers coupled to motors that are aligned to generate forces of thrust and/or lift, as well as one or more control surfaces such as wings, rudders, ailerons, elevators, flaps, brakes, slats or other features, that may be operated within desired ranges. Moreover, in some embodiments, one or more of the primary vehicle or the secondary vehicle may be a legged robot, e.g., a quadruped, a biped, a triped, a hexiped, or any other robot having any number of legs. For example, a primary vehicle or a secondary vehicle may have any number of servos or other systems for causing the robot to move or translate along or about any axis and in any direction by any number of legs.

The primary vehicles or the secondary vehicles may further include one or more components for engaging with one or more items, e.g., to retrieve or release such items, as well as cargo bays or storage compartments for carrying items therein, for maintaining such items at any desired temperature, pressure or alignment or orientation, or for protecting such items against the elements, as well as sensors for determining whether a cargo bay or other storage compartment is empty or includes one or more items, or for identifying specific items that are stored therein. The primary vehicles or the secondary vehicles may further include one or more display screens (e.g., touchscreen displays, scanners, keypads) having user interfaces for displaying information regarding such vehicles or their contents to humans, or for receiving interactions (e.g., instructions) from such humans, or other input/output devices for such purposes. In some embodiments, the primary vehicles or the secondary vehicles may be programmed or otherwise configured to automatically access one or more predetermined or specified locations, e.g., to automatically deliver an item to a given location or to retrieve items from the given location, such as by automatically opening doors or other entry points when authorized accordingly.

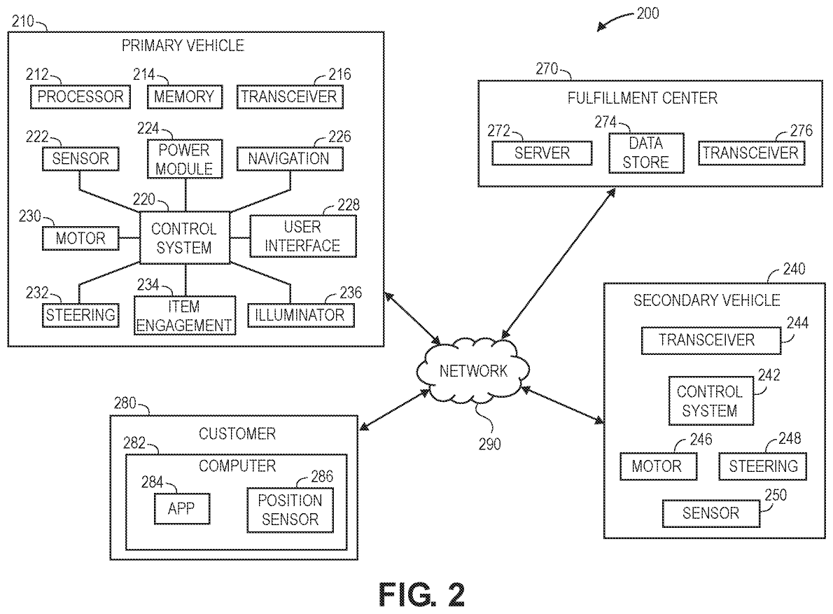

Referring to FIG. 2, a block diagram of components of one system 200 for directing secondary vehicles using primary vehicles in accordance with embodiments of the present disclosure is shown. The system 200 of FIG. 2 includes a primary vehicle 210, a secondary vehicle (or personal delivery device) 240, a fulfillment center 270 and a customer 280 that are connected to one another across a network 290, which may include the Internet in whole or in part. Except where otherwise noted, reference numerals preceded by the number “2” in FIG. 2 refer to elements that are similar to elements having reference numerals preceded by the number “1” shown in FIGS. 1A through 1N.

The primary vehicle 210 may be any type or form of self-powered vehicle capable of being programmed or otherwise configured for travel between two points along one or more paths or routes, in the performance of one or more missions or tasks, based on one or more computer instructions. In some embodiments, the primary vehicle 210 may be an automobile such as a car, a truck, a van, a tractor, or any other type or form of vehicle, such as a hovercraft. In some embodiments, the primary vehicle 210 may be an aerial vehicle (e.g., a manned or unmanned aerial vehicle, such as a drone), or an aquatic vehicle (e.g., a boat or a ship).

As is shown in FIG. 2, the primary vehicle 210 may include one or more computer components such as a processor 212, a memory 214 and a transceiver 216 in communication with one or more other computer devices that may be connected to the network 290, in order to transmit or receive information in the form of digital or analog data, or for any other purpose. As is also shown in FIG. 2, the primary vehicle 210 also includes one or more control systems 220, as well as one or more sensors 222, one or more power modules 224, one or more navigation modules 226, and one or more user interfaces 228. Additionally, the primary vehicle 210 may further include one or more motors 230, one or more steering systems 232, one or more item engagement systems (or devices) 234 and one or more illuminators 236 (or other feedback devices).

The processor 212 may be configured to perform any type or form of computing function associated with the operation of the primary vehicle 210 or the secondary vehicle 240, including but not limited to the execution of one or more algorithms or techniques (e.g., object detection or recognition algorithms or techniques) associated with one or more applications, purposes or functions, or to select at least one of a course, a speed or an altitude for the safe operation of the primary vehicle 210 or the secondary vehicle 240. For example, the processor 212 may be configured to control any aspects of the operation of the primary vehicle 210 and the one or more computer-based components thereon, including but not limited to the sensors 222, the power modules 224, the navigation modules 226 and/or the user interfaces 228, or the motors 230, the steering systems 232, the item engagement systems 234 or the illuminators 236, or the operation of the secondary vehicle 240. For example, the processor 212 may be configured to determine an optimal path or route between two locations for the execution of a given mission or task to be executed by the primary vehicle 210 or the secondary vehicle 240, such as according to one or more traditional shortest path or shortest route algorithms such as Dijkstra's Algorithm, Bellman-Ford Algorithm, Floyd-Warshall Algorithm, Johnson's Algorithm or a hub labeling technique.

The processor 212 may also control the operation of one or more control systems or modules, such as the control system 220, for generating instructions for conducting operations of one or more of the sensors 222, the power modules 224, the navigation modules 226 and/or the user interfaces 228, or the motors 230, the steering systems 232, the item engagement systems 234 or the illuminators 236, or for interpreting information or data captured by one or more onboard sensors, e.g., the sensors 222 or others (not shown). Such control systems or modules may be associated with one or more other computing devices or machines, and may communicate with the secondary vehicle 240, the fulfillment center 270, the customer 280, or one or more other computer devices or delivery vehicles (not shown) over the network 290, through the sending and receiving of digital data.

The processor 212 may be a uniprocessor system including one processor, or a multiprocessor system including several processors (e.g., two, four, eight, or another suitable number), and may be capable of executing instructions. For example, in some embodiments, the processor 212 may be a general-purpose or embedded processor unit such as a CPU or a GPU having any number of instruction set architectures (ISAs), such as the x86, PowerPC, SPARC, or MIPS ISAs, or any other suitable ISA. Where the processor 212 is a multiprocessor system, each of the processors within the multiprocessor system may operate the same ISA, or different ISAs.

Additionally, the primary vehicle 210 further includes one or more memory or storage components 214 (such as databases or data stores) for storing any type of information or data, e.g., instructions for operating the primary vehicle 210 or the secondary vehicle 240, or information or data captured during operations of the primary vehicle 210 or the secondary vehicle 240. For example, the memory 214 may be configured to store information or data regarding positions of obstructions, slopes, surface textures, terrain features, weather conditions, moisture contents or other conditions in various locations, as well as operating data, imaging data or any other information or data. The memory 214 may be configured to store executable instructions, imaging data, paths or routes, control parameters and/or other data items accessible by or to the processor 212. The memory 214 may be implemented using any suitable memory technology, such as random-access memory (or “RAM”), static RAM (or “SRAM”), synchronous dynamic RAM (or “SDRAM”), nonvolatile/Flash-type memory, or any other type of memory. In some embodiments, program instructions, imaging data, paths or routes, vehicle control parameters and/or other data items may be received or sent via the transceiver 216, e.g., by transmission media or signals, such as electrical, electromagnetic, or digital signals, which may be conveyed via a communication medium such as a wired and/or a wireless link.

The transceiver 216 may be configured to enable the primary vehicle 210 to communicate through one or more wired or wireless means, e.g., wired technologies such as Universal Serial Bus (or “USB”) or fiber optic cable, or standard wireless protocols such as Bluetooth® or any Wi-Fi protocol, e.g., to the secondary vehicle 240 or other systems, such as over the network 290 or directly. The transceiver 216 may further include or be in communication with one or more input/output (or “I/O”) interfaces, network interfaces and/or input/output devices, and may be configured to allow information or data to be exchanged between one or more of the components of the primary vehicle 210 or the secondary vehicle 240, or to one or more other computer devices or systems (e.g., other vehicles, not shown) via the network 290. For example, in some embodiments, the transceiver 216 may be configured to coordinate I/O traffic between the processor 212 and one or more onboard or external computer devices or components, e.g., the sensors 222, the power modules 224, the navigation modules 226 and/or the user interfaces 228, the motors 230, the steering systems 232, the item engagement systems 234 or the illuminators 236. The transceiver 216 may perform any necessary protocol, timing or other data transformations in order to convert data signals from a first format suitable for use by one component into a second format suitable for use by another component. In some embodiments, the transceiver 216 may include support for devices attached through various types of peripheral buses, e.g., variants of the Peripheral Component Interconnect (PCI) bus standard or the USB standard. In some other embodiments, functions of the transceiver 216 may be split into two or more separate components, or integrated with the processor 212.

The control system 220 may include one or more electronic speed controls, power supplies, navigation systems and/or payload engagement controllers for controlling aspects of the operation of the primary vehicle 210 or the secondary vehicle 240, as desired. For example, the control system 220 may be configured to cause or control the operation of one or more of the sensors 222, the power modules 224, the navigation modules 226 and/or the user interfaces 228, or the motors 230, the steering systems 232, the item engagement systems 234 or the illuminators 236, or one or more components of the secondary vehicle 240. For example, the motors 230 may be configured to rotate propellers or axles, or to otherwise generate forces of thrust and/or lift, on the primary vehicle 210. The control system 220 may further control any other aspects of the primary vehicle 210, including but not limited to the operation of one or more control surfaces (not shown) such as wings, rudders, ailerons, elevators, flaps, brakes, slats or other features within desired ranges, where the primary vehicle 210 is an aerial vehicle, or the engagement with or release of one or more items by one or more engagement systems (not shown). In some embodiments, the control system 220 may be integrated with one or more of the processor 212, the memory 214 and/or the transceiver 216.

The control system 220 may include one or more software applications or hardware components configured for controlling or monitoring operations of one or more components such as the sensors 222, the power module 224, the navigation module 226, or the user interfaces 228, as well as the motors 230, the steering systems 232, the item engagement systems 234 and the illuminators 236, e.g., by receiving, generating, storing and/or transmitting one or more computer instructions to such components. In some embodiments, the control system 220 may include one or more software applications or hardware components configured for controlling or monitoring operations of similar or counterpart components of the secondary vehicle 240. The control system 220 may communicate with the secondary vehicle 240, the fulfillment center 270 and/or the customer 280 over the network 290, through the sending and receiving of digital data.

The sensor 222 may include any number of sensors, e.g., a suite of such sensors, of any type or form. For example, the sensor 222 may be a position sensor such as a Global Positioning System (or “GPS”) receiver in communication with one or more orbiting satellites or other components of a GPS system, or any other device or component for determining geolocations (e.g., geospatially-referenced point that precisely defines an exact location in space with one or more geocodes, such as a set of geographic coordinates, e.g., a latitude and a longitude, and, optionally, an elevation that may be ascertained from signals (e.g., trilateration data or information) or geographic information system (or “GIS”) data), of the primary vehicle 210. Geolocations of the sensor 222 may be associated with the primary vehicle 210, where appropriate.

The sensor 222 may also be an imaging device including any form of optical recording sensor or device (e.g., digital cameras, depth sensors or range cameras, infrared cameras, radiographic cameras or other optical sensors) that may be configured to photograph or otherwise capture visual information or data (e.g., still or moving images in color or black and white that may be captured at any frame rates, or depth imaging data such as ranges), or associated audio information or data, or metadata, regarding objects or activities occurring within a vicinity of the primary vehicle 210, including but not limited to positions or orientations of the secondary vehicle 240, or for any other purpose. For example, the sensor 222 may be configured to capture or detect reflected light if the reflected light is within a field of view of the sensor 222, which is defined as a function of a distance between an imaging sensor and a lens within the sensor 222, viz., a focal length, as well as a position of the sensor 222 and an angular orientation of the lens. Accordingly, where an object appears within a depth of field, or a distance within the field of view where the clarity and focus is sufficiently sharp, the sensor 222 may capture light that is reflected off objects of any kind to a sufficiently high degree of resolution using one or more sensors thereof, and store information regarding the reflected light in one or more data files.

The sensor 222 may also include manual or automatic features for modifying a field of view or orientation. For example, the sensor 222 may be a digital camera configured in a fixed position, or with a fixed focal length (e.g., fixed-focus lenses) or angular orientation. Alternatively, the sensor 222 may include one or more actuated or motorized features for adjusting a position of the sensor 222, or for adjusting either the focal length (e.g., zooming the imaging device) or the angular orientation (e.g., the roll angle, the pitch angle or the yaw angle), by causing a change in the distance between the imaging sensor and the lens (e.g., optical zoom lenses or digital zoom lenses), a change in the location of the sensor 222, or a change in one or more of the angles defining the angular orientation of the sensor 222.

For example, the sensor 222 may be an imaging device that is hard-mounted to a support or mounting that maintains the imaging device in a fixed configuration or angle with respect to one, two or three axes. Alternatively, however, the sensor 222 may be provided with one or more motors and/or controllers for manually or automatically operating one or more of the components, or for reorienting the axis or direction of the sensor 222, i.e., by panning or tilting the sensor 222. Panning the sensor 222 may cause a rotation within a horizontal plane or about a vertical axis (e.g., a yaw), while tilting the sensor 222 may cause a rotation within a vertical plane or about a horizontal axis (e.g., a pitch). Additionally, the sensor 222 may be rolled, or rotated about its axis of rotation, and within a plane that is perpendicular to the axis of rotation and substantially parallel to a field of view of the sensor 222.

Imaging data (e.g., still or moving images, as well as associated audio data or metadata) captured using the sensor 222 may be processed according to any number of recognition techniques. In some embodiments, edges, contours, outlines, colors, textures, silhouettes, shapes or other characteristics of objects, or portions of objects, expressed in still or moving digital images may be identified using one or more algorithms or machine-learning tools. The objects or portions of objects may be stationary or in motion, and may be identified at single, finite periods of time, or over one or more periods or durations. Such algorithms or tools may be directed to recognizing and marking transitions (e.g., the edges, contours, outlines, colors, textures, silhouettes, shapes or other characteristics of objects or portions thereof) within the digital images as closely as possible, and in a manner that minimizes noise and disruptions, or does not create false transitions. Some detection algorithms or techniques that may be utilized in order to recognize characteristics of objects or portions thereof in digital images in accordance with the present disclosure include, but are not limited to, Canny edge detectors or algorithms; Sobel operators, algorithms or filters; Kayyali operators; Roberts edge detection algorithms; Prewitt operators; Frei-Chen methods; or any other algorithms or techniques that may be known to those of ordinary skill in the pertinent arts.

The sensor 222 may further be or include one or more compasses, speedometers, altimeters, inclinometers, thermometers, barometers, hygrometers, gyroscopes, air monitoring sensors (e.g., oxygen, ozone, hydrogen, carbon monoxide or carbon dioxide sensors), ozone monitors, pH sensors, moisture sensors, magnetic anomaly detectors, metal detectors, radiation sensors (e.g., Geiger counters, neutron detectors, alpha detectors), accelerometers, ranging sensors (e.g., radar, sonar or LIDAR ranging sensors) or sound sensors (e.g., microphones, piezoelectric sensors, vibration sensors or other transducers for detecting and recording acoustic energy from one or more directions).

The sensor 222 may be further configured to capture, record and/or analyze information or data regarding positions, velocities, accelerations or orientations of the primary vehicle 210, or of the secondary vehicle 240, and to analyze such data or information by one or more means, e.g., by aggregating or summing such data or information to form one or more qualitative or quantitative metrics of the movement of the sensor 222. For example, a net vector indicative of any and all relevant movements of the primary vehicle 210 or the secondary vehicle 240, including but not limited to physical positions, velocities, accelerations or orientations of the sensor 222, may be derived. Additionally, coefficients or scalars indicative of the relative movements of the primary vehicle 210 or the secondary vehicle 240 may also be defined.

Although the sensor 222 is shown as intrinsic to or onboard the primary vehicle 210, the primary vehicle 210 may utilize one or more sensors that are external to the primary vehicle 210 in the capture of information or data, or rely on information or data captured using such sensors, in accordance with the present disclosure. For example, the primary vehicle 210 may receive information or data regarding ground conditions at a location that was captured by one or more sensors at the location. Such external sensors may have any or all of the features or characteristics of the sensors 222 disclosed herein.

The power module 224 may be any type of power source for providing electrical power, mechanical power or other forms of power in support of one or more electrical or mechanical loads aboard the primary vehicle 210. In some embodiments, the power module 224 may include one or more batteries or other power cells, e.g., dry cell or wet cell batteries such as lead-acid batteries, lithium ion batteries, nickel cadmium batteries or nickel metal hydride batteries, or any other type, size or form of batteries. The power module 224 may each have any cell voltages, peak load currents, charge times, specific energies, internal resistances or cycle lives, or other power ratings. The power module 224 may also be any type, size or form of other power source, e.g., other than a battery, including but not limited to one or more fuel cells, turbines, solar cells or nuclear reactors. Alternatively, the power module 224 may be another form of prime mover (e.g., electric, gasoline-powered or any other type of motor) capable of generating sufficient mechanical forces for the primary vehicle 210.

The navigation module 226 may include one or more software applications or hardware components including or having access to information or data regarding aspects of transportation systems within a given region or space, including the locations, dimensions, capacities, conditions, statuses or other attributes of various paths or routes in the region or space. For example, the navigation module 226 may receive inputs from the sensor 222, e.g., from a GPS receiver, an imaging device or another sensor, and determine an optimal direction and/or an optimal speed of the primary vehicle 210 or the secondary vehicle 240 for travelling on a given path or route based on such inputs. The navigation module 226 may select a path or route to be traveled upon by the primary vehicle 210 or the secondary vehicle 240, and may provide information or data regarding the selected path or route to the control system 220.

The user interface 228 may be configured to receive and provide information to human users of the primary vehicle 210 or the secondary vehicle 240 and may include, but is not limited to, a display, (e.g., a touch-screen display), a scanner, a keypad, a biometric scanner, an audio transducer, one or more speakers, one or more imaging devices such as a video camera, and any other types of input or output devices that may support interaction between the primary vehicle 210 or the secondary vehicle 240 and a human user. In various embodiments, the user interface 228 may include a variety of different features. For example, in one embodiment, the user interface 228 may include a relatively small display and/or a keypad for receiving inputs from human users. In other embodiments, inputs for controlling the operation of the primary vehicle 210 or the secondary vehicle 240 may be provided remotely. For example, in order to access a storage compartment of the primary vehicle or the secondary vehicle 240, a human user may send a text message to or reply to a text message from the control system 220 and request that a door or other access portal be opened in order to enable the user to access an item therein. In various implementations, the primary vehicle 210 or the secondary vehicle 240 may have capabilities for directly receiving such signals from a user device or other device (e.g., a device inside a user's residence) that provides a signal to open the storage compartment door.

The motor 230 may be any type or form of motor or engine (e.g., electric, gasoline-powered or any other type of motor) that is capable of providing sufficient rotational forces to one or more axles, shafts and/or wheels for causing the primary vehicle 210 and any items therein to travel in a desired direction and at a desired speed. In some embodiments, the primary vehicle 210 may include one or more electric motors having any number of stators, poles and/or windings, such as an outrunner or an inrunner brushless direct current (DC) motor, or any other motors, having any speed rating, power rating or any other rating.

The steering system 232 may be any system for controlling a direction of travel of the primary vehicle 210. The steering system 232 may include any number of automatically operable gears (e.g., racks and pinions), gear boxes, shafts, shaft assemblies, joints, servos, hydraulic cylinders, linkages or other features for repositioning one or more wheels to cause the primary vehicle 210 to travel in a desired direction. Where the primary vehicle 210 is an aerial vehicle or an aquatic vehicle, the steering system 232 may further include one or more control surfaces such as wings, rudders, ailerons, elevators, flaps, brakes, slats or other features.

The item engagement system 234 may be any mechanical component, e.g., a robotic arm, for engaging an item or for disengaging the item, as desired. For example, when the primary vehicle 210 or the secondary vehicle 240 is tasked with delivering items or materials from an origin to a destination, the item engagement system 234 may be used to engage the items or materials at the origin and to deposit the items or materials in a cargo bay or other storage compartment prior to departing. After the primary vehicle 210 arrives at the destination, the item engagement system 234 may be used to retrieve the items or materials within the cargo bay or storage compartment, and deposit the items or materials in a desired location at the destination, including but not limited to a cargo bay or a storage compartment of the secondary vehicle 240.

In some embodiments, the primary vehicle 210 may be programmed or configured to perform one or more missions or tasks in an integrated manner. For example, the control system 220 may be programmed to instruct the primary vehicle 210 to travel to an origin, e.g., the fulfillment center 270, and to begin the performance of a task there, such as by retrieving an item at the origin using the item engagement system 234, before proceeding to a destination, e.g., the customer 280, along a selected route (e.g., an optimal route). Along the way, the control system 220 may cause the motor 230 to operate at any predetermined speed and cause the steering system 232 to orient the primary vehicle 210 in a predetermined direction or otherwise as necessary to travel along the selected route, e.g., based on information or data received from or stored in the navigation module 226. The control system 220 may further cause the sensor 222 to capture information or data (including but not limited to imaging data) regarding the primary vehicle 210 and/or its surroundings or environments along the selected route. The control system 220 or one or more other components of the primary vehicle 210 may be programmed or configured as necessary in order to execute any actions associated with a given task, in accordance with the present disclosure. Likewise, the control system 220 may also be programmed to execute any actions associated with a given task for the secondary vehicle 240.

The illuminator 236 may be any light or light source that is configured to project light in one or more directions. For example, in some embodiments, the illuminator 236 may be one or more light-emitting diodes (or “LED”), liquid crystal displays (or “LCD”), incandescent bulbs, compact and/or linear fluorescent bulbs, halogen lamps, metal halide lamps, neon lamps, sodium lamps or any other type or form of lights configured to project light at any frequency, wavelength or intensity. Alternatively, or in addition to the illuminator 236, the primary vehicle 210 or the secondary vehicle 240 may include one or more other feedback devices, including but not limited to components such as audio speakers or other physical components that may be automatically controlled or configured to generate audible messages, signals or sounds, or one or more haptic vibrating elements that may be automatically controlled or configured to generate tactile vibrations of any frequency or intensity.

Any of the functions or tasks described herein as being performed or executed by the primary vehicle 210 may be performed or executed by a remote computer system in communication with one or more secondary vehicles 240. Such a remote computer system may be fixed or mobile in nature, and may provide one or more sets of instructions to the secondary vehicle 240 over one or more networks, e.g., the network 290. Such a remote computer system may be provided within a vicinity of the secondary vehicle 240, or in one or more alternate or virtual locations, e.g., in a “cloud”-based environment.

The secondary vehicle 240 may be any type or form of vehicle that is configured to perform one or more tasks or functions, such as a delivery of an item, or to travel from one location to another location, at the direction of the primary vehicle 210. For example, in some embodiments, the secondary vehicle 240 may be an automobile such as a car, a truck, a van, a tractor, or any other type or form of vehicle, configured to receive instructions or other information or data from the primary vehicle 210 and to execute such instructions in the performance of the one or more tasks or functions.

The control system 242, the transceiver 244, the motors 246 or the steering systems 248 may include or share one or more of the properties or features of the control system 220, the transceiver 216, the motors 230 or the steering systems 232, respectively described herein, or any other properties or features.

Additionally, as is shown in FIG. 2, the secondary vehicle 240 may further include one or more sensors 250, e.g., position sensors, speedometers, inclinometers, thermometers, accelerometers, gyroscopes, compasses or other magnetometers, imaging devices (e.g., digital cameras), ranging sensors (e.g., radar, sonar or LIDAR ranging sensors) or acoustic sensors (e.g., microphones, vibration sensors), or other components, which may include or share one or more of the properties or features of the sensors 222 or such other components of the primary vehicle 210 respectively described herein, or any other properties or features.

In some embodiments, a number of the sensors 250 provided aboard the secondary vehicle 240 may be fewer than a corresponding number of the sensors 222 provided aboard the primary vehicle 210. In some embodiments, a level of quality, complexity, sophistication, technology or advancement of the sensors 250 provided aboard the secondary vehicle 240 may be lower than a corresponding level of quality, complexity, technology or advancement of the sensors 222 provided aboard the primary vehicle 210. In some embodiments, the secondary vehicle 240 need not include any sensors 250 other than any sensors or sensing equipment that may be required for or associated with the operation of one or more of the control system 242, the transceiver 244, the motors 246 or the steering systems 248.

The fulfillment center 270 may be any facility that is adapted to receive, store, process and/or distribute items. As is shown in FIG. 2, the fulfillment center 270 includes a server 272, a data store 274, and a transceiver 276. The fulfillment center 270 may also include one or more stations for receiving, storing and distributing items to customers.

The server 272 and/or the data store 274 may operate one or more order processing and/or communication systems and/or software applications having one or more user interfaces, or communicate with one or more other computing devices or machines that may be connected to the network 290, for transmitting or receiving information in the form of digital or analog data, or for any other purpose. For example, the server 272 and/or the data store 274 may also operate or provide access to one or more reporting systems for receiving or displaying information or data regarding orders for items received by a marketplace, and may provide one or more interfaces for receiving interactions (e.g., text, numeric entries or selections) from one or more operators, users, workers or other persons in response to such information or data. The server 272, the data store 274 and/or the transceiver 276 may be components of a general-purpose device or machine, or a dedicated device or machine that features any form of input and/or output peripherals such as scanners, readers, keyboards, keypads, touchscreens or like devices, and may further operate or provide access to one or more engines for analyzing the information or data regarding workflow operations, or the interactions received from the one or more operators, users, workers or persons.

For example, the server 272 and/or the data store 274 may be configured to determine an optimal path or route between two locations for the execution of a given mission or task to be executed by the primary vehicle 210 or the secondary vehicle 240, such as according to one or more traditional shortest path or shortest route algorithms such as Dijkstra's Algorithm, Bellman-Ford Algorithm, Floyd-Warshall Algorithm, Johnson's Algorithm or a hub labeling technique. Additionally, the server 272 and/or the data store 274 may be configured to control or direct, or to recommend or suggest, collaboration between or among one or more of the primary vehicle 210, the secondary vehicle 240 or the customer 280, in the performance of one or more tasks or in the execution of one or more functions. For example, the server 272 and/or the data store 274 may identify appropriate locations or rendezvous points where one or more humans, vehicles or other machines, e.g., the primary vehicle 210, the secondary vehicle 240 or the customer 280, may meet in order to transfer inventory or materials therebetween, or for any other purpose.

The transceiver 276 may be configured to enable the fulfillment center 270 to communicate through one or more wired or wireless means, e.g., wired technologies such as USB or fiber optic cable, or standard wireless protocols such as Bluetooth® or any Wi-Fi, such as over the network 290 or directly. The transceiver 276 may include or share one or more of the properties or features of the transceiver 216 described herein, or any other properties or features.

The fulfillment center 270 may further include one or more control systems that may generate instructions for conducting operations at one or more receiving stations, storage areas and/or distribution stations. Such control systems may be associated with the server 272, the data store 274 and/or the transceiver 276, or with one or more other computing devices or machines, and may communicate by any known wired or wireless means, or with the primary vehicle 210, the secondary vehicle 240 or the customer 280 over the network 290 through the sending and receiving of digital data.

Additionally, the fulfillment center 270 may include one or more systems or devices (not shown in FIG. 2) for locating or identifying one or more elements therein, such as cameras or other image recording devices. Furthermore, the fulfillment center 270 may also include one or more workers or staff members (not shown in FIG. 2), who may handle or transport items within the fulfillment center 270. Such workers may operate one or more computing devices or machines for registering the receipt, retrieval, transportation or storage of items within the fulfillment center, or a general-purpose device such as a personal digital assistant, a digital media player, a smartphone, a tablet computer, a desktop computer or a laptop computer, and may include any form of input and/or output peripherals such as scanners, readers, keyboards, keypads, touchscreens or like devices.

In some embodiments, the server 272, the data store 274 and/or the transceiver 276 may be associated with any type or form of facility, system or station, and need not be associated with a fulfillment center.

The customer 280 may be any entity or individual that wishes to download, purchase, rent, lease, borrow or otherwise obtain items (which may include goods, products, services or information of any type or form) from the fulfillment center 270, e.g., for delivery to a selected destination by the delivery vehicle 210 or by any other means. The customer 280 may utilize one or more computing devices 282 (e.g., a smartphone, a tablet computer, a laptop computer, a desktop computer, a smart speaker, or computing devices provided in wristwatches, televisions, set-top boxes, automobiles or any other appliances or machines), or any other like machine, that may operate or access one or more software applications 284, such as a web browser or a shopping application, and may be connected to or otherwise communicate with the primary vehicle 210, the secondary vehicle 240 or the fulfillment center 270 through the network 290 by the transmission and receipt of digital data. The computing devices 282 may also include one or more position sensors 286, which may be configured to determine positions of the computing devices 282, e.g., based on one or more GPS signals, cellular telephone signals, or signals received from any other source.

Although the block diagram of FIG. 2 shows a primary vehicle 210 as having single boxes for a processor 212, a memory component 214, a transceiver 216, a control system 220, a sensor 222, a power module 224, a navigation system 226, a user interface 228, a motor 230, a steering system 232, an item engagement system 234, an illuminator 236, and although the block diagram 2 of FIG. 2 shows a secondary vehicle 240 as having a single box for a control system 242, a single box for a transceiver 244, a single box for a motor 246, a single box for a steering system 248 and a single box for a sensor 250, as well as a single box for a fulfillment center 270 and a single box for a customer 280, those of ordinary skill in the pertinent arts will recognize that the system 200 may include or operate any number or type of primary vehicles, secondary vehicles, processors, memory components, transceivers, control systems, sensors, power modules, navigation systems, user interfaces, motors, steering systems, sensors, fulfillment centers or customers in accordance with the present disclosure.

Any combination of networks or communications protocols may be utilized in accordance with the systems and methods of the present disclosure. For example, each of the primary vehicle 210 and the secondary vehicle 240 may be configured to communicate with one another or with the server 272 and/or the computer 282 via the network 290, such as is shown in FIG. 2, e.g., via an open or standard protocol such as Wi-Fi. Alternatively, each of the primary vehicle 210 and the secondary vehicle 240 may be configured to communicate with one another directly outside of a centralized network, such as the network 290, e.g., by a wireless protocol such as Bluetooth, in which two or more of the primary vehicle 210 or the secondary vehicle 240 may be paired with one another. In some embodiments, the primary vehicle 210 and/or the secondary vehicle 240 may communicate with one another or with one or more external components or systems via a cellular network, a local area network (or “LAN”), a wide area network (or “WAN”), or any other network, including but not limited to a proprietary network. In some embodiments, the primary vehicle 210 and/or the secondary vehicle 240 may communicate with one another via software-defined radio systems, components or networks, e.g., at any selected frequency, bandwidth or sampling rate.

The computers, servers, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like, or to “select” an item, link, node, hub or any other aspect of the present disclosure.

Those of ordinary skill in the pertinent arts will understand that process steps described herein as being performed by a “primary vehicle,” a “secondary vehicle,” a “fulfillment center,” a “customer,” an “autonomous ground vehicle” (or “autonomous vehicle”), or like terms, may be automated steps performed by their respective computer systems, or implemented within software modules (or computer programs) executed by one or more general purpose computers. Moreover, process steps described as being performed by a “delivery vehicle,” a “fulfillment center,” a “customer,” or an “autonomous vehicle” may be typically performed by a human operator, but could, alternatively, be performed by an automated agent.

The primary vehicle 210, the secondary vehicle 240, the fulfillment center 270, or the customer 280 may use any web-enabled or Internet applications or features, or any other client-server applications or features including electronic mail (or E-mail), or other messaging techniques, to connect to the network 290 or to communicate with one another, such as through short or multimedia messaging service (SMS or MMS) text messages, social network messages, online marketplace messages, telephone calls or the like. For example, the fulfillment center 270 may be adapted to transmit information or data in the form of synchronous or asynchronous messages to the primary vehicle 210, the secondary vehicle 240 and/or the customer 280, or any other computer device in real time or in near-real time, or in one or more offline processes, via the network 290 or directly. Those of ordinary skill in the pertinent art would recognize that the primary vehicle 210, the secondary vehicle 240, the fulfillment center 270 or the customer 280, may include or operate any of a number of computing devices that are capable of communicating over the network. The protocols and components for providing communication between such devices are well known to those skilled in the art of computer communications and need not be described in more detail herein.

The data and/or computer-executable instructions, programs, firmware, software and the like (also referred to herein as “computer-executable” components) described herein may be stored on a computer-readable medium that is within or accessible by computers, computer components or control systems utilized by the primary vehicle 210, the secondary vehicle 240, the fulfillment center 270 or the customer 280, and having sequences of instructions which, when executed by a processor (e.g., a central processing unit, or “CPU”), cause the processor to perform all or a portion of the functions, services and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some embodiments of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, embodiments may also be provided as a computer-executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or including signals that may be downloaded through the Internet or other networks.

As is discussed above, in some embodiments, a primary vehicle may be configured to capture data regarding surroundings or environments in which the primary vehicle or a secondary vehicle is operating, and to control the operation of the secondary vehicle during the performance of one or more tasks within such surroundings or environments based on the captured data, even where numbers or levels of quality, complexity, sophistication, technology or advancement of sensors or other components provided on the secondary vehicle are limited.

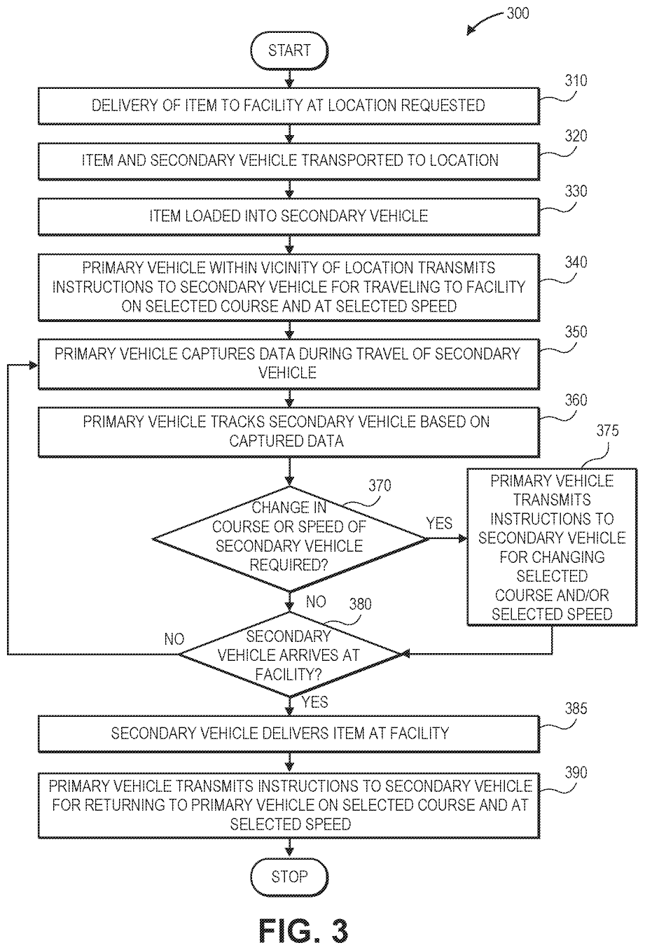

Referring to FIG. 3, a flow chart 300 of one process for directing secondary vehicles using primary vehicles in accordance with embodiments of the present disclosure is shown.

At box 310, a delivery of an item to a facility at a location is requested. For example, a customer or other user of an electronic marketplace may visit one or more network sites or access one or more applications to browse for offered items or other goods or services, and may request that one or more items of any type or form be delivered to a facility (e.g., a home, a building, or another structure) at a designated location. Alternatively, the customer or other user may visit a bricks-and-mortar retail establishment to request the delivery of the item to the facility, or request the delivery of the item to the facility by telephone or in any other manner.

At box 320, the item and a secondary vehicle (e.g., a personal delivery device) are transported to the location. In some embodiments, the item and the secondary vehicle may be transported to the location together. In some other embodiments, however, the item and the secondary vehicle may be transported to the location separately. For example, where one or more primary vehicles or secondary vehicles are utilized as a service, or where the primary vehicles or secondary vehicles are not directly affiliated with a fulfillment center, a marketplace or any other source of the item for which delivery was requested at box 310, the secondary vehicle may be delivered to the location independent of the item.

At box 330, the item is loaded into the secondary vehicle. For example, the item may be manually or automatically loaded into a cargo bay, a storage compartment, or another space or portion of the secondary vehicle manually or automatically, such as by an engagement system of the secondary vehicle or a primary vehicle, or in any other manner.

At box 340, a primary vehicle within the vicinity of the location transmits one or more instructions to the secondary vehicle to travel to the facility on a selected course and at a selected speed. In some embodiments, the primary vehicle may generate the instructions based on a general map or other representation of surfaces or conditions at the location, or based on any other information or data. In some other embodiments, however, the primary vehicle may capture data (e.g., images of surroundings or environments) regarding surfaces or other conditions at the location prior to generating the instructions or transmitting the instructions to the secondary vehicle. The secondary vehicle may include any number of wheels, e.g., one, two, four or six, and may be instructed to travel on the selected course and at the selected speed on any number or type of surfaces, including one or more roads, sidewalks, crosswalks, bicycle paths, trails or the like, as well as any number of yards, patios, driveways, sidewalks, walkways or other surfaces.

Moreover, in some embodiments, the item and the secondary vehicle may be transported to the location at box 320 while being carried by the primary vehicle, or coupled to the primary vehicle. In such embodiments, the item may be loaded into the secondary vehicle prior to loading the secondary vehicle into or coupling the secondary vehicle to the primary vehicle, as the primary vehicle and the secondary vehicle are en route to the location, after the primary vehicle and the secondary vehicle arrive at the location, or at any other time. Alternatively, the primary vehicle and the secondary vehicle may travel together to a location, in an uncoupled state or condition, but within a communication range of one another, and with the secondary vehicle traveling on courses or speeds selected in response to instructions received from the primary vehicle.

At box 350, the primary vehicle captures data during the travel of the secondary vehicle. For example, the primary vehicle may be equipped with one or more sensors, such as digital cameras, position sensors, navigational sensors, inclinometers, ranging sensors, acoustic sensors or other sensors, and may capture data to determine a status of the secondary vehicle or the surfaces on which the secondary vehicle travels, or the surroundings or environments of the primary vehicle or the secondary vehicle. The data may include, but is not limited to, digital images, reflections of radar or sonar emissions, LIDAR data, RFID data, strengths of wireless signals emitted by the secondary device and captured by the primary device, or any other data from which a position or orientation, or other information or data, regarding the primary vehicle may be obtained. In some embodiments, the secondary vehicle may include an extension or an appurtenance that extends above the secondary vehicle, in order to increase its visibility or enhance its chances of detection within data captured by the primary vehicle. In some embodiments, the secondary vehicle may also capture data of any type or form using one or more sensors provided thereon.

At box 360, the primary vehicle tracks the secondary vehicle based on the captured data. For example, where the data is captured over a period of time, a position and/or an orientation of the secondary vehicle may be determined directly and/or by other techniques, e.g., dead reckoning, based on the data. In some embodiments, such as where the secondary vehicle includes an extension or an appurtenance having one or more visual markings thereon, and such visual markings are fixed in their relative position with respect to the orientation of the secondary vehicle, the visual markings may be detected within imaging data or other data captured by the primary vehicle. In such embodiments, the secondary vehicle may be identified, and a position and an orientation of the secondary vehicle may be determined, upon detecting the visual markings within the imaging data. In some other embodiments, a secondary vehicle may be detected and tracked based on data captured by a primary vehicle in any other manner.

At box 370, whether a change in the course or the speed of the secondary vehicle is required is determined, e.g., based on the data captured by the primary vehicle at box 350, or on any other information or data, including but not limited to any data captured by the secondary vehicle and returned to the primary vehicle. For example, the data captured by the primary vehicle at box 350, or on any other information or data, may identify one or more obstructions within a vicinity of the secondary vehicle, or ahead of the secondary vehicle on the selected course (e.g., at a constant bearing from the secondary vehicle, and a decreasing range). Such obstructions may include fixed or mobile objects, such as one or more humans, non-human animals or machines. Alternatively, whether a change in the course or the speed of the secondary vehicle is required may be determined based on any other information or data, including but not limited to information or data obtained from sources other than the primary vehicle. For example, historic traffic or movement patterns may indicate that an obstruction that is not currently within a vicinity of the secondary vehicle may soon be present at or near the secondary vehicle. The data captured by the primary vehicle may also be evaluated with respect to one or more operating conditions or constraints of the secondary vehicle, e.g., dimensions (e.g., a length, width or height of the secondary vehicle, or an area or footprint occupied by the secondary vehicle), masses, traveling speeds, minimum turn radii, acoustic emissions, or speeds of the secondary vehicle, or other parameters, and determine whether a change in course or speed is based on such conditions or constraints.

If a change in the course or the speed of the secondary vehicle is required, the process advances to box 375, where the primary vehicle transmits one or more instructions for changing the selected course or the selected speed to the secondary vehicle. Such instructions may identify a newly selected course or a newly selected speed for the secondary vehicle or, alternatively or additionally, identify a location or position to or through which the secondary vehicle must travel, a time at which a change in the course and/or the speed must be executed, or a duration for which the secondary vehicle is to remain on the newly selected course or the newly selected speed. In some embodiments, the instructions may identify any other information or data regarding operations of the secondary vehicle, including but not limited to additional actions that are to be executed by the secondary vehicle during such operations. The instructions may take any form and may be transmitted at any time.

If a change in the course or the speed of the secondary vehicle is determined not to be required at box 370, or after the primary vehicle has transmitted instructions to the secondary vehicle for causing such a change at box 375, then the process advances to box 380, where whether the secondary vehicle has arrived at the facility to which delivery was requested is determined. The location or position of the secondary vehicle may be determined in any manner, e.g., based on data captured by the primary vehicle or obtained from another source, and compared to a known location or position of the facility, which may also be determined in any manner. For example, the primary vehicle may instruct the secondary vehicle to travel to a predetermined location or position previously associated with the facility or, alternatively, the location or position of the facility may be determined in any other manner, such as based on data captured by the primary vehicle or obtained from another source, and the primary vehicle may instruct the secondary vehicle to travel to the determined location or position.

At box 380, if the secondary vehicle has not arrived at the facility, the process returns to box 350, where the primary vehicle continues to capture data during the travel of the secondary vehicle, and to box 360, where the primary vehicle continues to track the secondary vehicle during its travel. If the secondary vehicle is determined to have arrived at the facility, however, then the process advances to box 385, where the secondary vehicle delivers the item at the facility. For example, where one or more personnel are available to receive the item at the facility, e.g., where the delivery is attended, the secondary vehicle may cause or enable one or more doors, hatches or other coverings of a cargo bay or storage compartment to be opened, and may transfer the item to such personnel at the location, e.g., by a robotic arm or other item engagement system, or enable the personnel to retrieve the item from the cargo bay or storage compartment. Where no personnel are available to receive the item at the facility, e.g., where the delivery is unattended, the secondary vehicle may release, deposit or otherwise discharge the item at the facility in any manner.

At box 390, the primary vehicle transmits one or more instructions to the secondary vehicle for returning to the primary vehicle on a selected course and a selected speed, and the process ends. For example, the primary vehicle may instruct the secondary vehicle to travel in a reciprocal fashion (e.g., courses that are one hundred eighty degrees opposite of the courses traveled to reach the facility, in a reverse order, and, optionally, at identical speeds). Alternatively, the secondary vehicle may perform steps or tasks that are similar to those described above with regard to boxes 340, 350, 360, 370, 375 and 380, with a goal of arriving not at the facility but at a location or position of the primary vehicle, or any other location or position, e.g., a location or a position associated with a next delivery of another item.

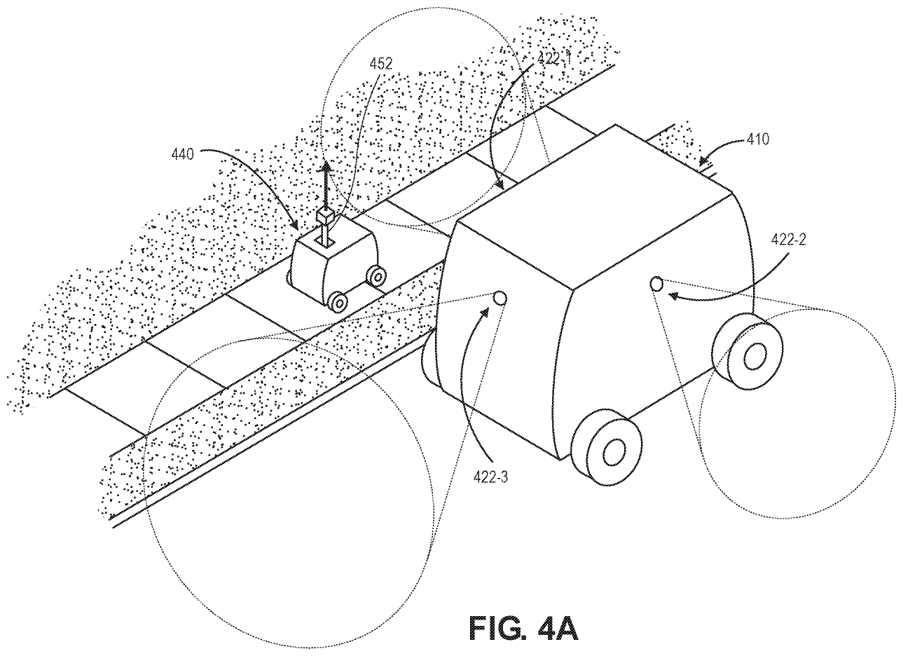

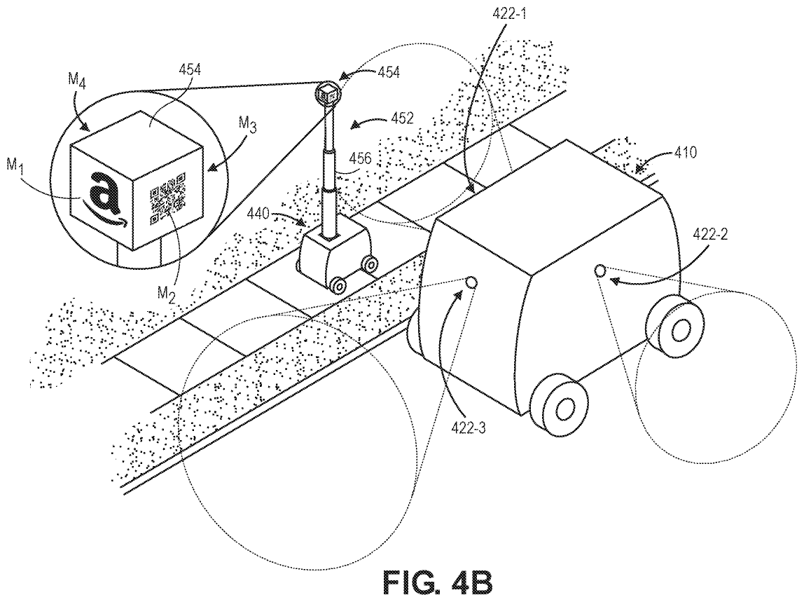

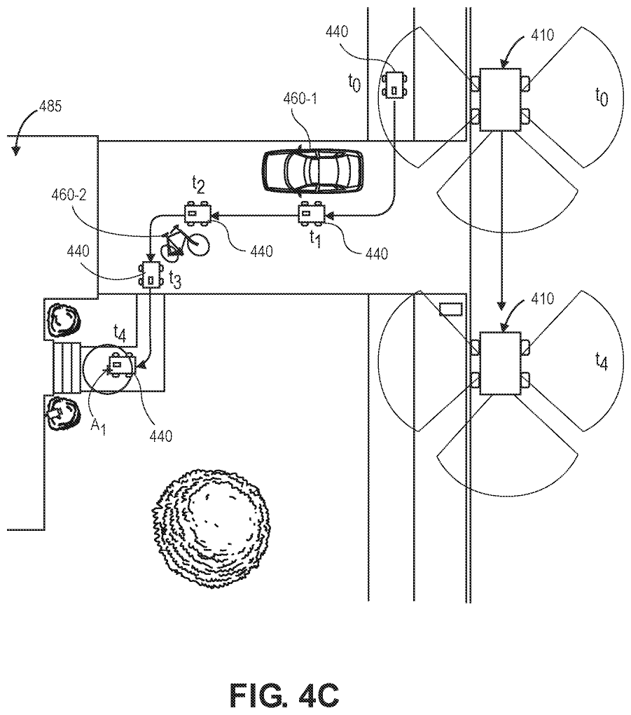

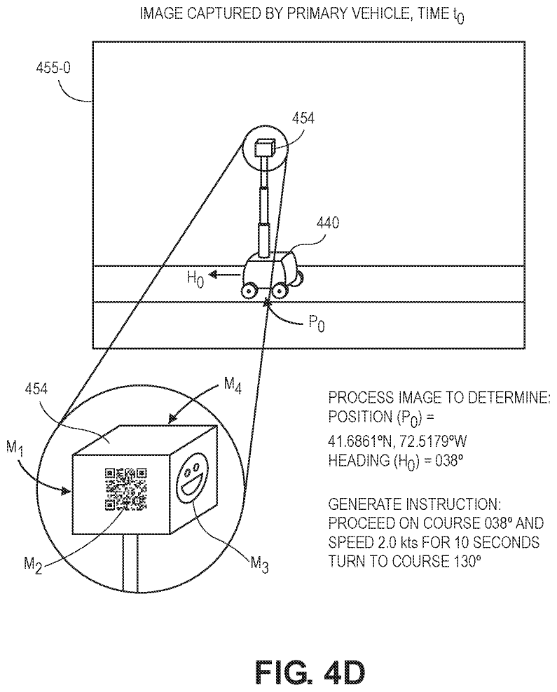

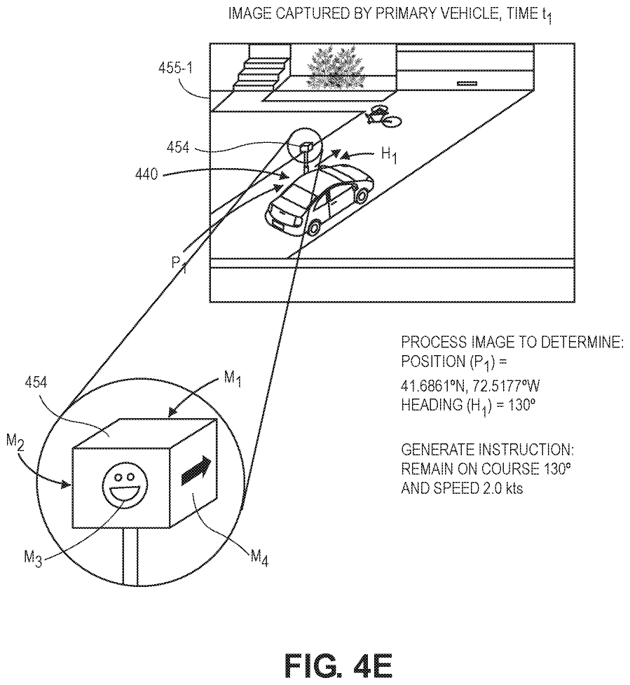

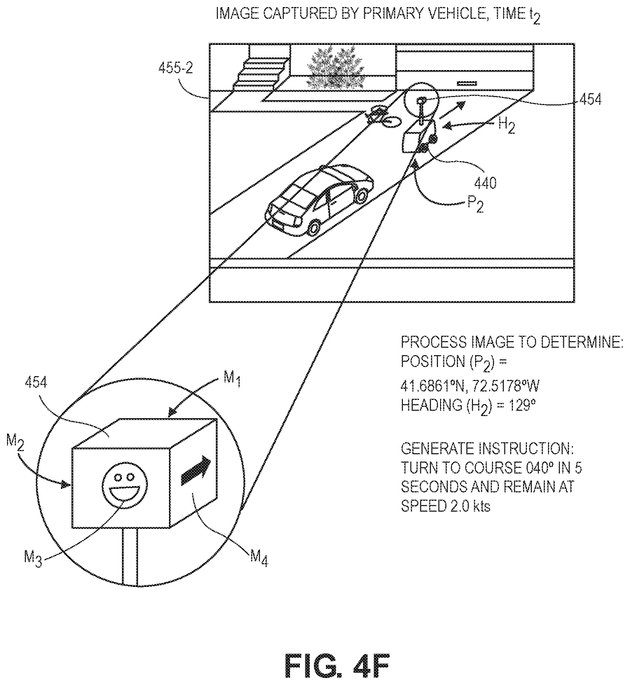

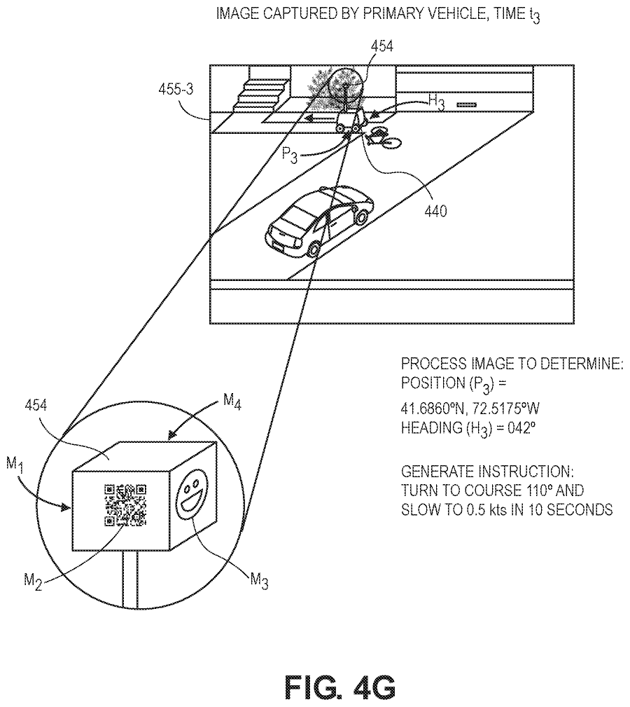

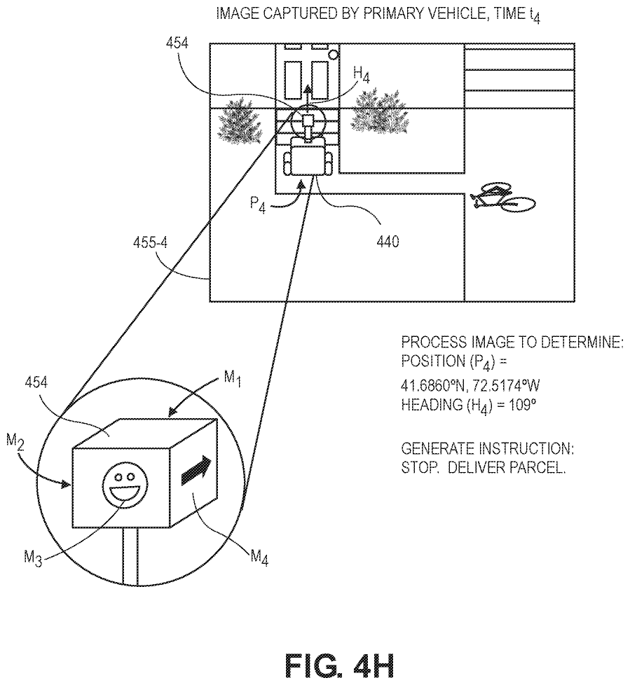

As is discussed above, in some embodiments, a primary vehicle may capture data (e.g., imaging data or other data) regarding surroundings or environments in which the primary vehicle or a secondary vehicle (such as a personal delivery device) operates, and generate instructions for directing the operations of the secondary vehicle based on the captured data. For example, a primary vehicle may transmit to a secondary vehicle, and the secondary vehicle may execute, one or more instructions identifying a change in a selected course or a selected speed, a time at which the secondary vehicle is to execute such changes, a duration for which the changes are to remain in effect, or a location or position to or through which the secondary vehicle should travel on the selected course and at the selected speed. Referring to FIGS. 4A through 4H, views of aspects of one system for directing secondary vehicles using primary vehicles in accordance with embodiments of the present disclosure are shown. Except where otherwise noted, reference numerals preceded by the number “4” in FIGS. 4A through 4H refer to elements that are similar to elements having reference numerals preceded by the number “2” in FIG. 2 or by the number “1” shown in FIGS. 1A through 1N.

As is shown in FIG. 4A, a primary vehicle 410 includes a plurality of digital cameras 422-1, 422-2, 422-3, with fields of view extending from a port side, from a starboard side, or forward of the primary vehicle 410, respectively, or in any other directions. Alternatively, the primary vehicle 410 may further include any number of other sensors (not shown). As is also shown in FIG. 4A, a secondary vehicle 440 further includes a fiducial 452 on an upper surface of a body of the secondary vehicle 440 that is configured to travel in a direction substantially normal to the upper surface, or in any other direction with respect to the body.

As is further shown in FIG. 4A, the secondary vehicle 440 is substantially smaller than the primary vehicle 410, such that each of a length, a width or a height of the secondary vehicle 440 is smaller than a length, a width, a height of the primary vehicle 410. Alternatively, in some other embodiments, the primary vehicle 410 and the secondary vehicle 440 may have the same dimensions or similar dimensions. In some embodiments, the primary vehicle 410 may transport or carry the secondary vehicle 440, or be coupled to the secondary vehicle 440, e.g., in a chain. Alternatively, the primary vehicle 410 and the secondary vehicle 440 may be configured to travel in a disconnected state, or independently from one another.

As is shown in FIG. 4B, the fiducial 452 is shown in a fully extended state. The fiducial 452 includes an extension 454 and a telescoping base 456. The extension 454 is a three-dimensional object with a discrete shape, e.g., a cube or other rectangular solid, and a plurality of visible markings M₁, M₂, M₃, M₄ disposed on outer surfaces of the extension 454. The visible markings M₁, M₂, M₃, M₄ may take the form of bar codes (e.g., one-dimensional or two-dimensional bar codes, such as “QR” codes, or “AprilTags”), alphanumeric characters, symbols, markings, or the like. Additionally, the telescoping base 456 may include one or more motors, hydraulic systems, pneumatic systems, or any other prime movers for placing the extension 454 at a desired height. For example, a height of the extension 454 may be selected based on a height of the secondary vehicle 440, a height of any objects that are known or expected to be within a vicinity of the secondary vehicle 440, in order to increase a likelihood that the extension 454 may be detected within data captured by the primary vehicle 410, e.g., images captured using one or more of the digital cameras 422-1, 422-2, 422-3. Moreover, while the extension 454 may be raised or lowered in a direction normal to an upper surface of the body of the secondary vehicle 440, the extension 454 has a fixed orientation with respect to an orientation of the secondary vehicle 440. Therefore, upon detecting the extension 454 within one or more images captured using the digital cameras 422-1, 422-2, 422-3, and recognizing one or more of the markings M₁, M₂, M₃, M₄ depicted therein, a position and/or an orientation of the secondary vehicle 440 may be determined based on the appearance of such visible markings within such images.

As is shown in FIG. 4C, the primary vehicle 410 may capture data using the cameras 422-1, 422-2, 422-3 or any other sensors, and detect the secondary vehicle 440 (e.g., the extension 454 of the fiducial 452) based on the data, before generating and transmitting one or more sets of instructions for causing the secondary vehicle 440 to travel to a delivery area A₄ at the destination 485 based on the data over a period of time including times t₀, t₁, t₂, t₃, t₄. The primary vehicle 410 may capture the data using the cameras 422-1, 422-2, 422-3 or any other sensors while the primary vehicle 410 is fixed in position or in motion over the period of time from time t₀ to time t₄, or prior to or after this period of time. In some embodiments, the primary vehicle 410 may also receive data captured by one or more sensors provided aboard the secondary vehicle 440 (not shown) while the primary vehicle 410 is fixed in position or in motion over the period of time from time t₀ to time t₄, or prior to or after this period of time, and utilize data captured using such sensors in generating and transmitting one or more sets of instructions for causing the secondary vehicle 440 to travel to the delivery area A₄ take any other actions.

For example, as is shown in FIG. 4D, the primary vehicle 410 captures an image 455-0 at the time t₀, and processes the image 455-0 to detect the extension 454 of the fiducial 452 depicted therein. By detecting the marking M₂, viz., a two-dimensional bar code, on one face of the extension 454, and the marking M₃, viz., an emoji, on another face of the extension 454, within the image 455-0, the primary vehicle 410 may determine an orientation of the extension 454 at the time t₀ based on the image 455-0. Because the orientation of the extension 454 is fixed with respect to the orientation of the secondary vehicle 440, the primary vehicle 410 may also determine a position P₀ and a heading H₀ (or orientation) of the secondary vehicle 440 at the time t₀ based on the image 455-0, such as where a position of the primary vehicle 410 at the time t₀ is known.

Upon determining the position P₀ and the heading H₀ of the secondary vehicle 440 at the time t₀, the primary vehicle 410 may select one or more instructions for causing the secondary vehicle 440 to travel to the delivery area A₄. For example, as is shown in FIG. 4D, the instructions may call for the secondary vehicle 440 to travel on a selected course and at a selected speed for a duration before executing a change in course.

Similarly, as is shown in FIG. 4E, the primary vehicle 410 captures an image 455-1 at the time t₁, and processes the image 455-1 to detect the extension 454 of the fiducial 452 depicted therein. By detecting the marking M₃ on one face of the extension 454, and the marking M₄, viz., an arrow, on another face of the extension 454, within the image 455-1, the primary vehicle 410 may determine an orientation of the extension 454 at the time t₁ based on the image 455-1. Because the orientation of the extension 454 is fixed with respect to the orientation of the secondary vehicle 440, the primary vehicle 410 may also determine a position P₁ and a heading H₁ (or orientation) of the secondary vehicle 440 at the time t₁ based on the image 455-1, such as where a position of the primary vehicle 410 at the time t₁ is known.

Upon determining the position P₁ and the heading H₁ of the secondary vehicle 440 at the time t₁, the primary vehicle 410 may select one or more instructions for causing the secondary vehicle 440 to travel to the delivery area A₄. As is shown in FIG. 4E, the instructions may call for the secondary vehicle 440 to remain on the selected course and on the selected speed.

As is shown in FIG. 4F, the primary vehicle 410 captures an image 455-2 at the time t₂, and processes the image 455-2 to detect the extension 454 of the fiducial 452 depicted therein. By detecting the marking M₃ on one face of the extension 454, and the marking M₄ on another face of the extension 454, within the image 455-2, the primary vehicle 410 may determine an orientation of the extension 454 at the time t₂ based on the image 455-2. Because the orientation of the extension 454 is fixed with respect to the orientation of the secondary vehicle 440, the primary vehicle 410 may also determine a position P₂ and a heading H₂ (or orientation) of the secondary vehicle 440 at the time t₂ based on the image 455-2, such as where a position of the primary vehicle 410 at the time t₂ is known.

Upon determining the position P₂ and the heading H₂ of the secondary vehicle 440 at the time t₂, the primary vehicle 410 may select one or more instructions for causing the secondary vehicle 440 to travel to the delivery area A₄. As is shown in FIG. 4F, the instructions call for the secondary vehicle 440 to execute a change in the selected course at a future time, and to remain at the selected speed.

As is shown in FIG. 4G, the primary vehicle 410 captures an image 455-3 at the time t₃, and processes the image 455-3 to detect the extension 454 of the fiducial 452 depicted therein. By detecting the marking M₂ on one face of the extension 454, and the marking M₃ on another face of the extension 454, within the image 455-3, the primary vehicle 410 may determine an orientation of the extension 454 at the time t₃ based on the image 455-3. Because the orientation of the extension 454 is fixed with respect to the orientation of the secondary vehicle 440, the primary vehicle 410 may also determine a position P₃ and a heading H₃ (or orientation) of the secondary vehicle 440 at the time t₃ based on the image 455-3, such as where a position of the primary vehicle 410 at the time t₃ is known.

Upon determining the position P₃ and the heading H₃ of the secondary vehicle 440 at the time t₃, the primary vehicle 410 may select one or more instructions for causing the secondary vehicle 440 to travel to the delivery area A₄. As is shown in FIG. 4G, the instructions call for the secondary vehicle 440 to execute a change in the selected course and the selected speed (e.g., to slow the secondary vehicle 440) at a future time.

Finally, as is shown in FIG. 4H, the primary vehicle 410 captures an image 455-4 at the time t₄, and processes the image 455-4 to detect the extension 454 of the fiducial 452 depicted therein. By detecting the marking M₃ on one face of the extension 454, and the marking M₄ on another face of the extension 454, within the image 455-4, the primary vehicle 410 may determine an orientation of the extension 454 at the time t₄ based on the image 455-4. Because the orientation of the extension 454 is fixed with respect to the orientation of the secondary vehicle 440, the primary vehicle 410 may also determine a position P₄ and a heading H₄ (or orientation) of the secondary vehicle 440 at the time t₄ based on the image 455-4, such as where a position of the primary vehicle 410 at the time t₄ is known.

Upon determining the position P₄ and the heading H₄ of the secondary vehicle 440 at the time t₄, the primary vehicle 410 may select one or more instructions for causing the secondary vehicle 440 to travel to the delivery area A₄. As is shown in FIG. 4H, the secondary vehicle 440 is at or near the delivery area A₄, and the instructions call for the secondary vehicle 440 to stop and deliver the parcel. Subsequently, the primary vehicle 410 may select one or more instructions for causing the secondary vehicle 440 to travel to a location or position of the primary vehicle 410, or to any other location, as desired.

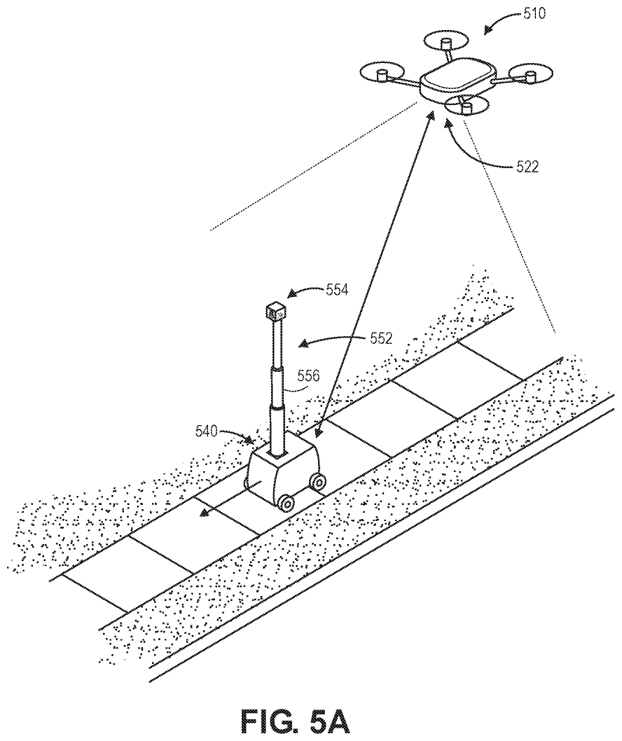

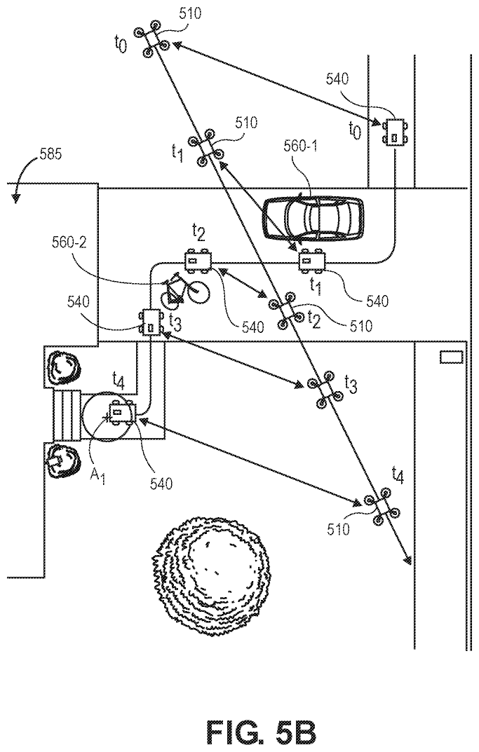

As is also discussed above, a primary vehicle that directs the operations of a secondary vehicle such as a personal delivery device may be an aerial vehicle, or an aquatic vehicle. Referring to FIGS. 5A and 5B, views of aspects of one system for directing secondary vehicles using primary vehicles in accordance with embodiments of the present disclosure are shown. Except where otherwise noted, reference numerals preceded by the number “5” in FIGS. 5A and 5B refer to elements that are similar to elements having reference numerals preceded by the number “4” in FIGS. 4A through 4H, by the number “2” in FIG. 2 or by the number “1” shown in FIGS. 1A through 1N.

As is shown in FIG. 5A, a primary vehicle 510 is an aerial vehicle engaged in airborne operations, with an imaging device 522 or other sensor having a field of view aligned substantially downward and configured to capture imaging data or other data from below a body of the primary vehicle 510. Additionally, the primary vehicle 510 is configured for wireless communication with a secondary vehicle 540 having a fiducial 552 with an extension 554 at a distal end of a telescoping base 556 that may place the extension 554 of the fiducial 552 at any desired height, e.g., by one or more motors, hydraulic systems, pneumatic systems, or any other prime movers.

As is shown in FIG. 5B, the primary vehicle 510 flies overhead as the secondary vehicle 540 travels along one or more ground surfaces to a delivery area A₅ associated with a destination 585. The primary vehicle 510 may provide one or more sets of instructions for causing the secondary vehicle 540 to travel at any selected courses or speeds, and may capture imaging data or other data regarding the secondary vehicle 540 while flying overhead, e.g., using the imaging device 522. The primary vehicle 510 may process the imaging data or other data to recognize the extension 554 of the fiducial 552 or other aspects of the secondary vehicle 540, or any obstructions 560-1, 560-2 depicted or otherwise represented therein, and to determine positions or orientations of the secondary vehicle 540 or such obstructions 560-1, 560-2. Subsequently, the primary vehicle 510 may generate one or more additional sets of instructions for directing the operations of the secondary vehicle 540, and transmit such instructions to the secondary vehicle 540. The primary vehicle 510 may further determine whether any of the sets of instructions provided to the secondary vehicle 540 were executed or not executed, and also confirm that a delivery to the delivery area A₅ was properly made, or take any other actions.

Alternatively, those of ordinary skill in the pertinent arts will recognize that a primary vehicle may be an aquatic vehicle, e.g., a seagoing vessel that may generate and transmit one or more instructions regarding operations of a secondary vehicle based on any data captured or received and interpreted by the primary vehicle.

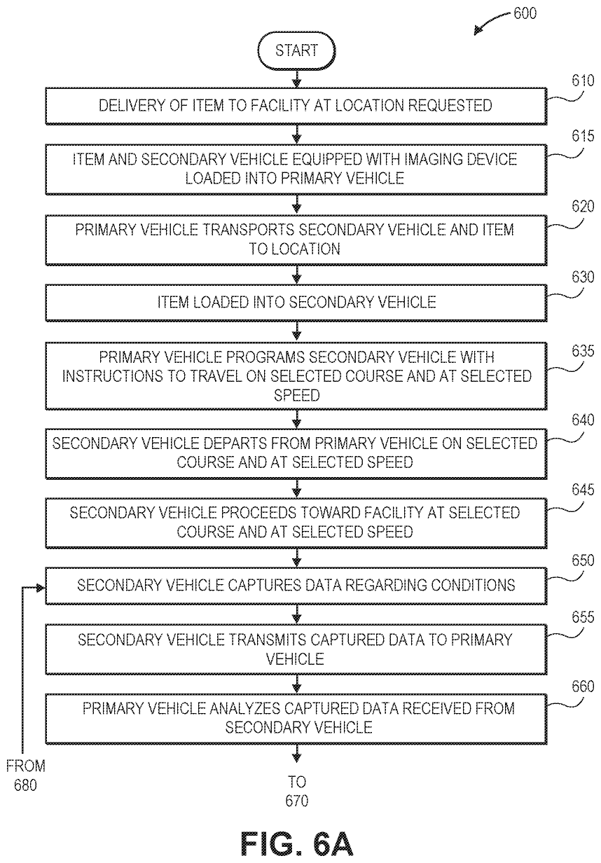

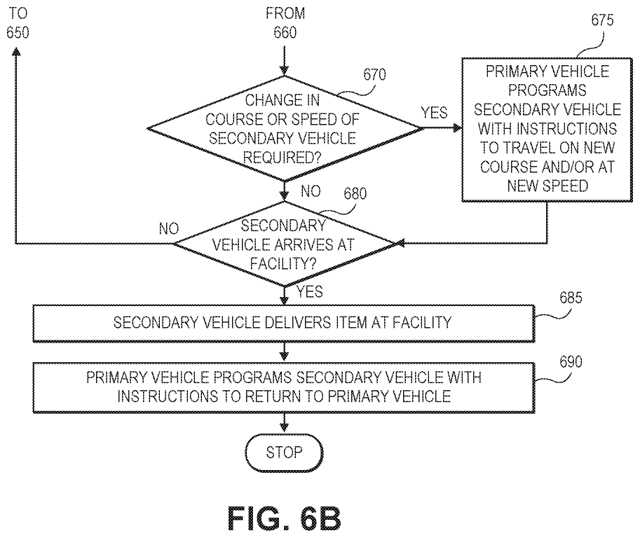

As is further discussed above, a secondary vehicle, such as a personal delivery device, may be outfitted with one or more sensors (e.g., imaging devices, position sensors, or others) that may capture data as the secondary vehicle travels under the direction of a primary vehicle. The secondary vehicle may return the captured data (e.g., images, coordinates or other data) to the primary vehicle, which may process or analyze the captured data and generate one or more instructions for operating the secondary vehicle based on the captured data. Referring to FIGS. 6A and 6B, a flow chart 600 of one process for directing secondary vehicles using primary vehicles in accordance with embodiments of the present disclosure is shown.

At box 610, a delivery of an item to a facility at a location is requested, e.g., via a browser or a shopping application associated with an electronic marketplace, by telephone or in person, or in any other manner. At box 615, the item and a secondary vehicle (e.g., a personal delivery device) equipped with a sensor (e.g., an imaging device, a position sensor, or others) are loaded into a primary vehicle. For example, the item may be manually or automatically loaded into the primary vehicle in any manner, and the secondary vehicle may be lifted, carried, rolled or otherwise transported into the primary vehicle, such as is shown in FIG. 1A. Alternatively, the secondary vehicle may be coupled to the primary vehicle in any manner, e.g., in a chain of ground vehicles including the primary vehicle and the secondary vehicle, or, where the primary vehicle is an aerial vehicle, to one or more surfaces of an underside or other surface of the aerial vehicle. The item may be transported or carried in one or more cargo bays or other compartments of the primary vehicle or the secondary vehicle.

At box 620, the primary vehicle transports the secondary vehicle and the item to the location, e.g., on one or more ground surfaces, or by air, along one or more paths or routes. At box 630, the item is loaded into the secondary vehicle, either manually or automatically, such as by an engagement system of the secondary vehicle or the primary vehicle, or in any other manner.

At box 635, the primary vehicle programs the secondary vehicle with one or more instructions to travel on a selected course and at a selected speed. The instructions may be generated based on previously available information, e.g., a general map or other representation of surfaces or conditions at the location, or based on any other information or data, including but not limited to data (e.g., images of surroundings or environments) captured by the primary vehicle upon arriving at the location.

At box 640, the secondary vehicle departs from the primary vehicle on the selected course and at the selected speed, e.g., by causing one or more motors to rotate wheels at the selected speeds, and by causing a steering system to place the secondary vehicle on the selected course. At box 650, the secondary vehicle captures data regarding conditions of the surroundings in which the secondary vehicle travels. For example, the secondary vehicle sensor may be a digital camera, a position sensor, an accelerometer, a gyroscope, a compass, an inclinometer, a ranging sensor, or an acoustic sensor, or any other sensors, such as two or more of such sensors, and the data may be digital images, reflections of radar or sonar emissions, LIDAR data, RFID data, or any other data.

At box 655, the secondary vehicle transmits the captured data to the primary vehicle, e.g., over one or more wireless networks. At box 660, the primary vehicle analyzes the captured data received from the secondary vehicle. For example, the primary vehicle may process the data to detect and identify objects that may be present within a vicinity of the secondary vehicle, to determine locations of such objects, or any natural or artificial obstructions or features along a path or route of the secondary vehicle or nearby, as well as to identify one or more slopes, surface textures, terrain features, weather conditions, moisture contents or the like on surfaces that may be located forward of or near the secondary vehicle. In some embodiments, the primary vehicle may use the captured data to construct a profile of the surroundings or the environment in which the secondary vehicle operates. For example, the primary vehicle may generate or update such a profile to include elevations or contours of grounds, locations of natural or artificial obstructions or features (e.g., trees, people, vehicles), or to define safe ranges or distances around such obstructions or features. The profile may further include information or data describing or characterizing such grounds, e.g., by dimensions or locations of the obstructions or features, or with classifications or characterizations of the obstructions or features, such as types of materials from which the surfaces are formed (e.g., cement, concrete, dirt, grass, gravel, mud, pavement, or the like), or conditions of the surfaces (e.g., dry, icy, moist, snowy, wet).

At box 670, whether a change in the course or the speed of the secondary vehicle is required is determined based on the data captured by the secondary vehicle, alone or in combination with any other data. For example, based on locations of any natural or artificial obstructions or features identified from the captured data, a profile generated based on the captured data, or any other information, whether the secondary vehicle must turn, slow down or speed up to either avoid any obstructions or features, or to travel to a predetermined location or position, may be determined. If a change in the course or the speed of the secondary vehicle is required, then the process advances to box 675, where the primary vehicle programs the secondary vehicle with instructions to travel on a newly selected course or at a newly selected speed. For example, the primary vehicle may transmit to the secondary vehicle, and the secondary vehicle may execute, one or more instructions identifying a change in the selected course or the selected speed, a time at which the secondary vehicle is to execute the change, a duration for which the change is to remain in effect, or a location or position to or through which the secondary vehicle should travel.

If no change in the course or the speed of the secondary vehicle is required, or after the secondary vehicle has been programmed with instructions to travel on the newly selected course or at the newly selected speed, the process to box 680, where whether the secondary vehicle has arrived at the facility is determined. For example, the primary vehicle may determine a location or position of the secondary vehicle based on data captured by the secondary vehicle or any other data, and compare the location or position of the secondary vehicle to a known location or position of the facility, which may also be determined in any manner.

If the secondary vehicle has not yet arrived at the facility, then the process advances to box 650, where the secondary vehicle captures additional data regarding conditions of its surroundings, and to box 655, where the secondary vehicle transmits the captured data to the primary vehicle.

If the secondary vehicle has arrived at the facility, however, then the process advances to box 685, where the secondary vehicle delivers the item at the facility, e.g., by an attended delivery in which a person at the facility is given or is permitted to retrieve the item from the secondary vehicle, or by an unattended delivery in which the item is automatically released, deposited or otherwise discharged at the facility.

At box 690, the primary vehicle programs the secondary vehicle with instructions to return to the primary vehicle or, alternatively, to another location, and the process ends. Such instructions may cause the secondary vehicle to travel to the primary vehicle along reciprocal paths or a reciprocal route, or along any other route, and at any desired speed. Alternatively, the secondary vehicle and the primary vehicle may perform steps or tasks that are similar to those described above with regard to boxes 640, 650, 655, 660, 670, 675 and 680, with a goal of arriving not at the facility but at a location or position of the primary vehicle, or any other location or position, e.g., a location or a position associated with a next delivery of another item.

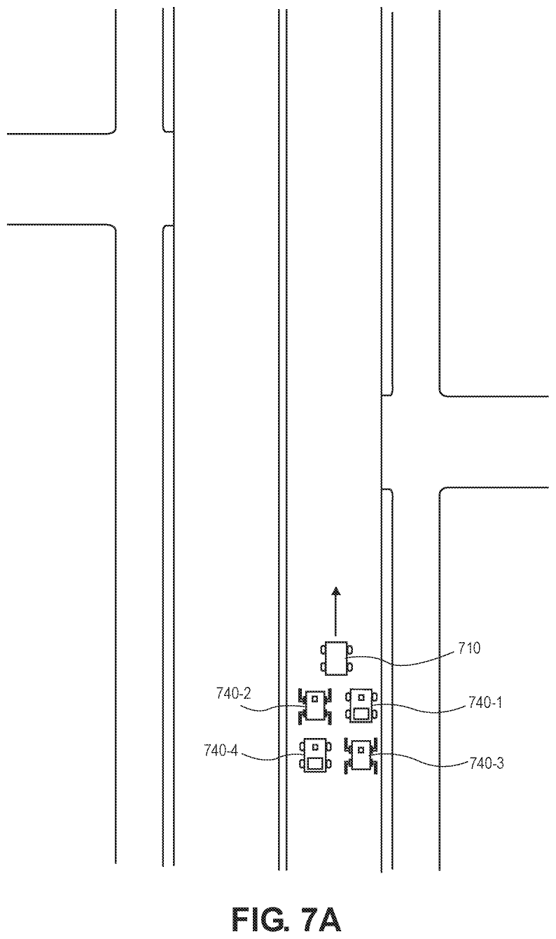

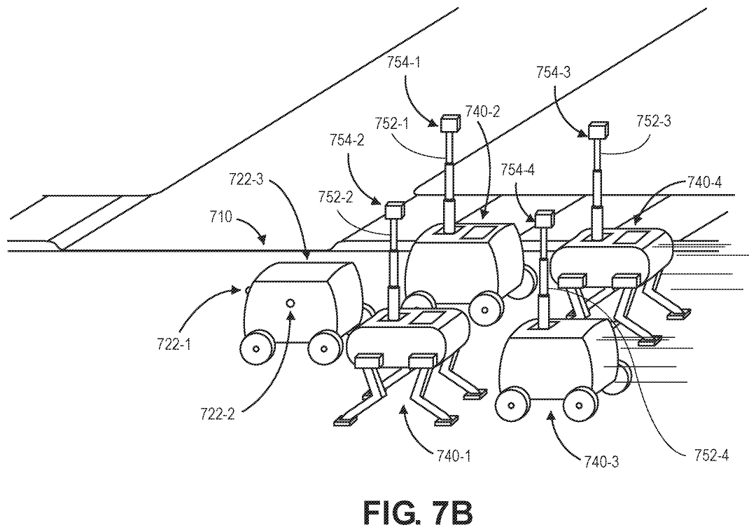

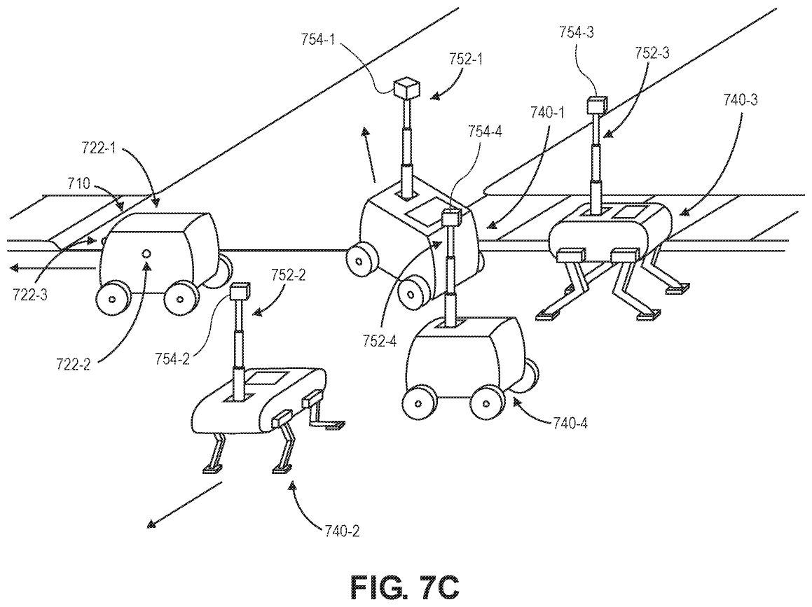

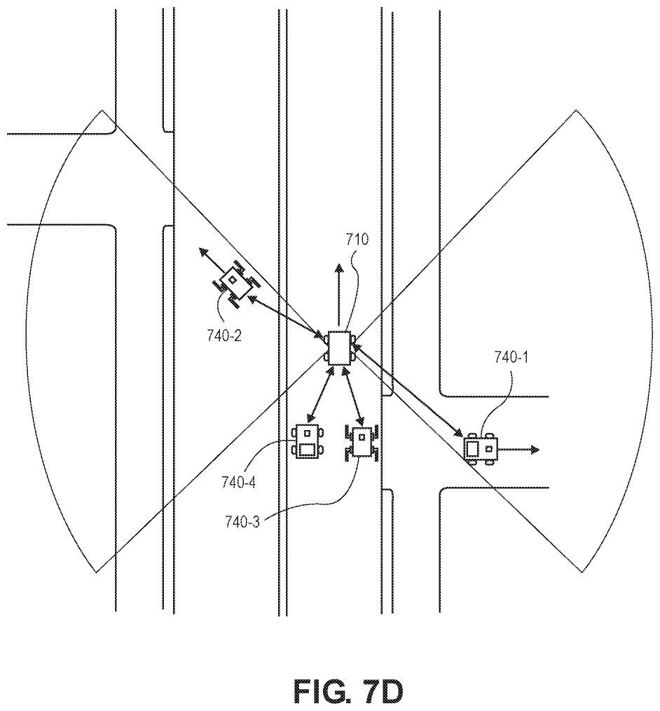

As is discussed above, a primary vehicle may be functionally or physically coupled to any number of personal delivery devices or other secondary vehicles, e.g., in a chain, and transported to a location where one or more tasks or functions are to be performed by the secondary vehicles. The primary vehicle may instruct one or more of the secondary vehicles to travel at one or more selected courses or selected speeds while performing the one or more tasks or functions. Referring to FIGS. 7A through 7D, views of aspects of one system for directing secondary vehicles using primary vehicles in accordance with embodiments of the present disclosure are shown. Except where otherwise noted, reference numerals preceded by the number “7” in FIGS. 7A through 7D refer to elements that are similar to elements having reference numerals preceded by the number “5” in FIGS. 5A and 5B, by the number “4” in FIGS. 4A through 4H, by the number “2” in FIG. 2 or by the number “1” shown in FIGS. 1A through 1N.

As is shown in FIGS. 7A and 7B, a primary vehicle 710 and a plurality of secondary vehicles 740-1, 740-2, 740-3, 740-4 (e.g., a detachment, a fleet, a platoon) travel as a unit down a roadway, a street, or another area that is sized or configured to accommodate the vehicles. The primary vehicle 710 is a mobile robot having a plurality of digital cameras 722-1, 722-2, 722-3, with fields of view extending from a port side, from a starboard side, and forward of the primary vehicle 710, respectively, or in any other directions. Alternatively, the primary vehicle 710 may further include any number of other sensors (not shown). As is shown in FIGS. 7A and 7B, the secondary vehicles 740-1, 740-4 are wheeled robots, and the secondary vehicles 740-2, 740-3 are legged robots (e.g., quadruped robots). As is also shown in FIG. 7B, each of the secondary vehicles 740-1, 740-2, 740-3, 740-4 includes a fiducial (or appurtenance) 752-1, 752-2, 752-3, 752-4 having an extension 754-1, 754-2, 754-3, 754-4 on a distal end thereof.

As is shown in FIGS. 7A and 7B, the secondary vehicles 740-1, 740-2, 740-3, 740-4 travel within a communications range of the primary vehicle 710, e.g., in a formation or arrangement, and exchange data or instructions therebetween at any rate or frequency. For example, the primary vehicle 710 may capture data regarding the surroundings or the environments in which the primary vehicle 710 or the secondary vehicles 740-1, 740-2, 740-3, 740-4 are operating, and generate and transmit instructions to the respective secondary vehicles 740-1, 740-2, 740-3, 740-4 for traveling at selected courses and speeds, e.g., in parallel and at equal speeds, or on other courses or at other speeds. Alternatively, in some embodiments, the primary vehicle 710 may receive data regarding the surroundings or the environments in which the primary vehicle 710 or the secondary vehicles 740-1, 740-2, 740-3, 740-4 are operating, e.g., from one or more of the secondary vehicles 740-1, 740-2, 740-3, 740-4, and may generate and transmit instructions to the respective secondary vehicles 740-1, 740-2, 740-3, 740-4 based on the data received from the one or more of the secondary vehicles 740-1, 740-2, 740-3.

Alternatively, in some embodiments, the primary vehicle 710 may be physically coupled to one or more of the secondary vehicles 740-1, 740-2, 740-3, 740-4, or may physically transport or carry one or more of the secondary vehicles 740-1, 740-2, 740-3, 740-4 to a given location. For example, in some embodiments, the primary vehicle 710 and the secondary vehicles 740-1, 740-2, 740-3, 740-4 may be configured for travel under their own respective power or, alternatively, with one or more of such vehicles providing a motive force for each of the respective vehicles, e.g., by towing or pushing.

Although FIG. 7A shows a single primary vehicle 710 and four secondary vehicles 740-1, 740-2, 740-3, 740-4 that are in communication with and operating under instructions received from the primary vehicle 710, any number of primary vehicles or secondary vehicles may be functionally or physically coupled to one another in accordance with the present disclosure, and such vehicles may include any number of sensors or other components, including or in addition to digital cameras.

As is shown in FIGS. 7C and 7D, when the primary vehicle 710 and the secondary vehicles 740-1, 740-2, 740-3, 740-4 arrive at or near one or more destinations for the performance of one or more tasks or functions, the primary vehicle 710 may generate and transmit one or more sets of instructions for causing one or more of the secondary vehicles 740-1, 740-2 to break away from the primary vehicle 710 and the secondary vehicles 740-3, 740-4, and to travel on selected courses and at selected speeds. Moreover, the primary vehicle 710 may further capture information or data using the imaging devices 722-1, 722-2, 722-3 or other sensors (not shown), or receive information or data from any sensors provided aboard the secondary vehicles 740-1, 740-2, 740-3, 740-4 or in any other location, and process the captured or received information or data to generate subsequent sets of instructions for directing the operations of each of the secondary vehicles 740-1, 740-2, 740-3, 740-4. Upon completing one or more missions, e.g., deliveries of items to destinations, the primary vehicle 710 may generate and transmit one or more sets of instructions to the secondary vehicles 740-1, 740-2, including but not limited to sets of instructions for causing the secondary vehicles 740-1, 740-2 to return to locations or positions within a vicinity of the primary vehicle 710, e.g., in formation with the secondary vehicles 740-3, 740-4 or elsewhere, or to travel to another location or position, e.g., to perform one or more subsequent tasks or functions.

Although some of the embodiments of the present disclosure depict the use of vehicles, e.g., primary vehicles and secondary vehicles, for deliveries of items to destinations, those of ordinary skill in the pertinent arts will recognize that the systems and methods of the present disclosure are not so limited. Rather, primary vehicles may be configured to direct the operations of personal delivery devices or other secondary vehicles for any purpose, e.g., during the performance of any type of mission and are not limited to deliveries of items. Moreover, although some of the embodiments of the present disclosure depict primary vehicles or secondary vehicles that are small in size, those of ordinary skill in the pertinent arts will recognize that the systems and methods of the present disclosure are not so limited. Rather, primary vehicles or secondary vehicles may be of any size or shape, and may be configured or outfitted with components or features that enable such vehicles to capture information or data, to generate one or more sets of instructions, or to communicate with any extrinsic computer devices or systems in accordance with the present disclosure.

It should be understood that, unless otherwise explicitly or implicitly indicated herein, any of the features, characteristics, alternatives or modifications described regarding a particular embodiment herein may also be applied, used, or incorporated with any other embodiment described herein, and that the drawings and detailed description of the present disclosure are intended to cover all modifications, equivalents and alternatives to the various embodiments as defined by the appended claims. Moreover, with respect to the one or more methods or processes of the present disclosure described herein, including but not limited to the flow charts shown in FIG. 3 or 6, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale. In the drawings, the use of the same or similar reference numbers in different figures indicates the same or similar items or features. Except where otherwise noted, left-most digit(s) of a reference number identify a figure in which the reference number first appears, while two right-most digits of a reference number in a figure indicate a component or a feature that is similar to components or features having reference numbers with the same two right-most digits in other figures.

Conditional language, such as, among others, “can,” “could,” “might,” or “may,” unless specifically stated otherwise, or otherwise understood within the context as used, is generally intended to convey in a permissive manner that certain embodiments could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The elements of a method, process, or algorithm described in connection with the embodiments disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD-ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative embodiments thereof, the foregoing and various other additions and omissions may be made therein and thereto without departing from the spirit and scope of the present disclosure.

What is claimed is:

1. A system comprising:
a first ground vehicle comprising a first body, a first processor unit disposed within the first body, a first motor disposed within the first body, a first digital camera having a field of view extending from at least a first surface of the first body, and a first transceiver disposed within the first body; and
a second ground vehicle comprising a second body, a second processor unit disposed within the second body, a second motor disposed within the second body, a second transceiver disposed within the first body, a fiducial extending from a second surface of the second body, and a storage compartment within the second body,
wherein the first processor unit is programmed with one or more sets of instructions that, when executed, cause the first ground vehicle to perform a method comprising:
generating a first set of instructions for causing the second vehicle to travel on a first course and at a first speed;
transmitting, by the first transceiver, the first set of instructions to the second transceiver;
capturing first imaging data by the first digital camera at a first time;
detecting at least a portion of the fiducial within the first imaging data;
determining a position of the second vehicle and an orientation of the second vehicle at the first time based at least in part on the portion of the fiducial detected within the first imaging data;
generating a second set of instructions for causing the second vehicle to travel on at least one of a second course or at a second speed; and
transmitting, by the first transceiver, the second set of instructions to the second transceiver at a second time, wherein the second time follows the first time.

2. The system of claim 1, wherein detecting at least the portion of the fiducial within the first imaging data comprises:
detecting an obstruction within the first imaging data; and
determining a position of the obstruction at the first time based at least in part on the first imaging data,
wherein the second set of instructions is generated based at least in part on the position of the obstruction at the first time.

3. The system of claim 1, wherein the method further comprises:
capturing second imaging data by the first digital camera at a third time, wherein the third time follows the second time;
detecting at least the portion of the fiducial within the second imaging data;
determining a position of the second vehicle and an orientation of the second vehicle at the third time based at least in part on the second imaging data;
generating a third set of instructions for causing the second vehicle to deliver at least one item from the storage compartment; and
transmitting, by the first transceiver, the third set of instructions to the second transceiver at a fourth time, wherein the fourth time follows the third time.

4. A method comprising:
generating, by a first processor unit provided aboard a first vehicle in an area, a first set of instructions, wherein the first set of instructions are configured to cause a second vehicle in the area to travel on a first course and at a first speed;
transmitting, by a first transceiver provided aboard the first vehicle, the first set of instructions to a second transceiver provided aboard the second vehicle;
causing, by a second processor unit aboard the second vehicle, the second vehicle to travel on the first course and the first speed in response to executing the first set of instructions by the second processor unit;
identifying, by the first processor unit, first data captured by at least one sensor in the area, wherein the first data was captured at a second time, and wherein the second time follows the first time;
determining, by the first processor unit based at least in part on the first data, at least one of:
a position of the second vehicle at the second time;
a position of an obstruction at the second time; or
an orientation of the second vehicle at the second time;
generating, by the first processor unit, a second set of instructions based at least in part on at least one of the position of the second vehicle at the second time, the position of the obstruction at the second time, or the orientation of the second vehicle at the second time; and
transmitting, by the first transceiver, the second set of instructions to the second transceiver.

5. The method of claim 4, wherein detecting the at least one of the position of the second vehicle at the second time, the position of the obstruction at the second time or the orientation of the second vehicle at the second time comprises:
receiving, by the first transceiver, the position of the second vehicle at the second time and the orientation of the second vehicle at the second time from the second transceiver,
wherein the position and the orientation are determined by at least one sensor provided aboard the second vehicle.

6. The method of claim 4, wherein the second set of instructions are configured to cause the second vehicle to at least one of:
deliver an item; or
travel on a second course or a second speed,
in response to executing the second set of instructions by the second processor unit.

7. The method of claim 4, wherein the at least one sensor is provided aboard the first vehicle,
wherein the at least one sensor comprises at least one imaging device,
wherein the first data comprises imaging data captured by the at least one imaging device at the second time, and
wherein generating the second set of instructions comprises:
selecting at least one of the second course or the second speed based at least in part on the first data.

8. The method of claim 7, wherein the second vehicle does not include any of an imaging device or a position sensor.

9. The method of claim 7, wherein determining the at least one of the position of the second vehicle at the second time, the position of the obstruction at the second time, or the orientation of the second vehicle at the second time comprises:
detecting at least one visual marking on at least a portion of a fiducial extending from a body of the second vehicle within the imaging data, wherein the at least one visual marking is provided on a first surface of the fiducial, and wherein an orientation of the fiducial is fixed with respect to an orientation of the second vehicle;
determining the position of the second vehicle based at least in part on the at least one visual marking; and
determining the orientation of the second vehicle based at least in part on the at least one visual marking,
wherein the at least one of the second course or the second speed is selected based on the position of the second vehicle and the orientation of the second vehicle.

10. The method of claim 7, wherein determining the at least one of the position of the second vehicle at the second time, the position of the obstruction at the second time, or the orientation of the second vehicle at the second time comprises:
generating a profile of one or more ground surfaces based at least in part on the first data, wherein the profile comprises:
the position of the obstruction on the one or more ground surfaces;
an elevation of the one or more ground surfaces;
a location of at least one slope of the one or more ground surfaces; or
a location of at least one surface texture of the one or more ground surfaces,
wherein the at least one of the second course or the second speed is selected based on the profile.

11. The method of claim 6, wherein the at least one sensor is provided aboard the second vehicle,
wherein the at least one sensor comprises at least one of a speedometer, an accelerometer, an inclinometer, a gyroscope, a magnetometer, a compass, an imaging device, a ranging sensor or an acoustic sensor, and
wherein the generating the second set of instructions comprises:
selecting at least one of the second course or the second speed based at least in part on the first data.

12. The method of claim 10, wherein determining the at least one of the position of the second vehicle at the second time, the position of the obstruction at the second time, or the orientation of the second vehicle at the second time comprises:
generating a profile of one or more ground surfaces based at least in part on the first data, wherein the profile comprises:
the position of the obstruction on the one or more ground surfaces;
an elevation of the one or more ground surfaces;
a location of at least one slope of the one or more ground surfaces; or
a location of at least one surface texture of the one or more ground surfaces,
wherein the at least one of the second course or the second speed is selected based on the profile.

13. The method of claim 4, wherein the first vehicle is a ground vehicle comprising:
a body, wherein the at least one sensor is coupled to the body;
at least one storage compartment disposed within the body;
the first processor unit;
the first transceiver;
at least one wheel; and
a motor disposed within the body, wherein the motor is configured to cause the at least one wheel to rotate at a speed within a predetermined speed range.

14. The method of claim 4, wherein the second set of instructions are configured to cause the second vehicle to travel on a second course or at a second speed, and
wherein the method further comprises:
causing, by the second processor unit, the second vehicle to travel on the second course or at the second speed in response to executing the second set of instructions by the second processor unit;
identifying, by the second processor unit, second data captured by the at least one sensor in the area, wherein the second data was captured at a third time, and wherein the third time follows the second time;
determining, by the first processor unit based at least in part on the second data, that the second vehicle is within a vicinity of at least a portion of a delivery area at the third time;
generating, by the first processor unit, a third set of instructions based at least in part on the second data, wherein the third set of instructions are configured to cause the second vehicle to deposit an item at the delivery area;
transmitting, by the first transceiver, the third set of instructions to the second transceiver; and
causing, by the second processor unit, the second vehicle to deliver the item at the delivery area in response to executing the third set of instructions by the second processor unit.

15. The method of claim 4, wherein the first vehicle is an aerial vehicle comprising:
a body, wherein the at least one sensor is coupled to the body;
at least one storage compartment disposed within the body;
the first processor unit;
the first transceiver;
at least one motor coupled within the body, wherein the at least one motor is configured to cause at least one propeller to rotate at a speed within a predetermined speed range; and
at least one power module for powering the motor.

16. The method of claim 4, further comprising:
transporting, by one of the first vehicle or a third vehicle, the second vehicle to the area prior to the first time,
wherein the second vehicle is coupled to or carried by the first vehicle prior to the first time.

17. The method of claim 4, wherein the first set of instructions is transmitted from the first transceiver to the second transceiver according to at least one of:
a Bluetooth protocol;
a Wireless Fidelity protocol;
a cellular network;
a local area network;
a wide area network; or
a software-defined area network.

18. A method comprising:
receiving, over a network, a first order for a delivery of an item, wherein the first order specifies a destination for the delivery of the item;
transporting, by a first vehicle, the item and a second vehicle to an area including the destination prior to a first time;
selecting, by a first processor unit aboard the first vehicle, a first course and a first speed for the second vehicle;
programming, by the first processor unit, the second vehicle to travel at the first course and the first speed at the first time;
capturing first data by at least one sensor provided aboard one of the first vehicle or the second vehicle, wherein the first data comprises first imaging data;
selecting, by the first processor unit, at least one of a second course or a second speed based at least in part on the first imaging data;
programming, by the first processor unit, the second vehicle to travel at the second course or the second speed at a second time, wherein the second time follows the first time;
capturing second data by the at least one sensor, wherein the second data comprises second imaging data;
detecting, by the first processor unit, a delivery area associated with the destination in the second imaging data; and
programming, by the first processor unit, the second vehicle to deposit the item at the delivery area at a third time, wherein the third time follows the second time.

19. The method of claim 18, wherein the at least one sensor is provided aboard the first vehicle,
wherein the second vehicle comprises a body having a fiducial with a visual marking thereon mounted to a distal end of the extension, wherein an orientation of the visual marking is fixed with respect to an orientation of the second vehicle,
wherein the second vehicle does not include an imaging device,
wherein selecting the first course and the first speed for the second vehicle comprises:
detecting at least a portion of the visual marking within the first imaging data; and
determining at least one of a position or an orientation of the second vehicle at a third time based at least in part on the first imaging data, wherein the third time is between the first time and the second time, and
wherein the second course or the second speed is selected based at least in part on the position or the orientation of the second vehicle at the third time.

20. The method of claim 18, wherein selecting the at least one of the second course or the second speed comprises:
determining at least one of a position of the second vehicle or an orientation of the second vehicle at a third time, wherein the third time is between the first time and a second time;
generating a profile of one or more ground surfaces in the area based at least in part on the first imaging data, wherein the profile comprises:
a position of the obstruction on the one or more ground surfaces;
an elevation of the one or more ground surfaces; or
a location of at least one slope of the one or more ground surfaces; or
a location of at least one surface texture of the one or more ground surfaces,
wherein the at least one of the second course or the second speed is selected based on the profile.
